(19) United States
(12) Patent Application Publication
(10) Pub. No.: US 2021/0256067 A1
(43) Pub. Date: Aug. 19, 2021

(54) DATABASE ENGINE FOR AMORPHOUS DATA SETS

(71) Applicant: Lester Frederick Nelson, Carlsbad, CA (US)

(72) Inventor: Lester Frederick Nelson, Carlsbad, CA (US)

(21) Appl. No.: 17/302,352

(22) Filed: Apr. 30, 2021

Related U.S. Application Data
(63) Continuation-in-part of application No. 16/685,669, filed on Nov. 15, 2019.
(60) Provisional application No. 63/018,738, filed on May 1, 2020.
(60) Provisional application No. 62/858,318, filed on Jun. 6, 2019.
(60) Provisional application No. 62/768,913, filed on Nov. 18, 2018.

(51) Int. Cl. G06F 16/9035; G06F 16/903; G06F 16/901; G06F 16/9032

(52) U.S. Cl. CPC G06F 16/9035; G06F 16/90332; G06F 16/9024; G06F 16/90335

(57) ABSTRACT

Systems and methods for a database engine (“dbe”) that handles amorphous data. In one example, a dbe includes processors coupled to non-transitory computer storage mediums the processors configured to execute the processor-executable instructions to operate a database engine to configure the one or more computer memory components to (1) store information in a database, the database including a Database Version Information String, “next entry” number and a plurality of entries, each entry structure including components of the entry, each of the components including information comprising (i) a component name, (ii) a component type, and (iii) data of the component, wherein each component is contained in only one entry, and each component being of one type of a numeric data type, a text data type, a date data type, or a connection data type, and (2) perform a transaction to store, retrieve and/or change information stored in the database.

### RELATED APPLICATIONS

This application claims the benefit of U.S. Provisional 63/018,738, filed May 1, 2020, and is a continuation-in-part of U.S. application Ser. No. 16/685,669, filed Nov. 15, 2019, which claims the benefit of U.S. Provisional 62/858,318, filed Jun. 6, 2019, and U.S. Provisional 62/768,913, filed Nov. 18, 2018. Each of the above-referenced disclosures is incorporated by reference herein in its entirety.

### TECHNICAL FIELD

The present disclosure relates to a database engine and techniques for direct entry of disparate, amorphous data and establishment of hierarchical, flat, and custom-defined relationships between these disparate data entries.

### BACKGROUND

Current, mainstream database technologies can require complex query languages or specialized data documents (JSON, XML) to store or access (query) data, such as SQL for relational databases, such as MySQL or MariaDB, or the hard-to-read and complicated JSON/Javascript approach as done with no-sql databases, such as MongoDB and CouchDB. Consequently, such databases can require a relatively long time to learn the techniques to properly enter data, query data, and delete data from the database. Also, some databases, such as Amazon Neptune, may need complex, specialized graph query languages such as Apache TinkerPop or W3C SPARQL for Graph Database interactions. In addition, current relational and nosql databases require creating a database schema (and corresponding up-front data modeling) before using them.

It would be advantageous to overcoming these and other problems with current databases, have a database that is essentially “language-less” with a fast-learning curve, and that allows easy entry of disparate, amorphous data and establishment of hierarchical, flat, and custom-defined relationships between these disparate data entries without requiring up-front data modeling schema design.

### SUMMARY

Various embodiments of the present disclosure provide a number of improvements to the functioning of a computer for storing data using the described embodiments of an Entry structure (sometimes referred to herein as an “Entry”) and a Component structure (sometimes referred to herein as a “Component”). Using the described embodiments of the Entry structures and the Component structures, no preplanning or no pre-defined/predetermined schema are needed, and the logical Entry structures (and the one or more Component structures of the Entry structures) can be defined and populated with data content. Accordingly, a user does not have to predefine or preplan even a single table to hold data content, instead defining the Entry/Component structures as the data content is stored. As used herein, an “Entry/Component structure(s)” refers to an Entry structure and the Component structures of the Entry structure (see for example, FIG. 2). For example, before a database engine processes the data content to be stored in an Entry structure, the Entry structure can have an undetermined size, number of components, and types of components, and before a database engine processes the data content to store it in a Component structure, the type of data (e.g., numeric data, text data, date data, or connection data) and the size of the Component structure can be undetermined (e.g., not predefined). In addition, the type of data in the Component structure can be revised at any time. Also, whether or not a Component structure indicates a connection between the Component structure's respective Entry structure another Entry structure can be defined at the time data is stored in the Component structure and changed at any time.

One innovation includes a data storage and retrieval system, including one or more non-transitory computer storage mediums configured to store processor-executable instructions, one or more processors coupled to the one or more non-transitory computer storage mediums, wherein the one of more processors are configured to execute the processor-executable instructions to: configure the one or more non-transitory computer memory components according to a plurality of logical entry structures and component structures as data content is being processed for storage in the entry structures. Each entry structure can include (i) an Entry Name, (ii) a list of keywords (Fast Find), (iii) an entry structure size, (iv) a unique entry structure number, (v) a status of the entry structure, (vi) a total number of component structures in the entry structure, each entry structure having one or more component structures, and (vii) the component structures in the respective entry structure. And each of the component structures in a respective entry structure includes (i) a component structure name, (ii) a component structure type, and (iii) component data content, each component structure being contained in only one entry structure, wherein each respective component structure in an entry structure defined as one of a numeric data type, a text data type, a date data type, or a connection data type, and wherein each connection data type component structure including an entry structure number indicating an entry structure having a hierarchical connection to the respective entry structure.

Various aspects of embodiments can include one or more of other features described herein. For example, in one aspect the one or more processors are configured to execute the processor-executable instructions to perform a transaction to change information stored in an entry structure of the plurality of entry structures. In another aspect, the at least one component of the plurality of entry structures includes a connection data type component structure. In another aspect, the connection data type component is an explosion-type connection component structure comprising an entry structure number. In another aspect, the explosion-type connection component structure further comprises a reference designator. In another aspect, the connection data type component structure is an implosion-type connection component structure comprising an entry structure number. In another aspect, the connection data type component is a flat-type connection component structure comprising an entry structure number. In another aspect, the connection data type component structure is a custom-type connection component structure comprising a connection entry structure number. In another aspect, the one or more processors are configured to execute the processor-executable instructions to store a first entry structure of the plurality of entry structures, the first entry structure including a first entry number and an explosion-type connection component structure, and store a second entry structure of the plurality of entry structures, the second entry structure including a second entry structure number and an implosion-type connection component structure, wherein the second entry structure implosion-type connection component includes the first entry structure number indicating the first entry structure has a superordinate hierarchical relationship relative to the second entry structure, and wherein the first entry structure explosion-type connection component structure includes the second entry structure number indicating the second entry structure has a subordinate hierarchical relationship relative to the first entry structure.

In another aspect, the one of more processors are configured to execute the processor-executable instructions to store a first entry structure of the plurality of entries, the first entry structure including a first entry structure number and an implosion-type connection component structure, and store a second entry of the plurality of entry structures, second entry structure including a second entry structure number and an explosion-type connection component structure, wherein the second entry explosion-type connection component structure includes the first entry structure number indicating the second entry structure has a subordinate hierarchical relationship to the first entry structure, and wherein the first entry structure implosion-type connection component structure includes the second entry structure number indicating the first entry structure has superordinate hierarchical connection to the second entry structure. In another aspect, the one of more processors are configured to execute the processor-executable instructions to store a first entry structure of the plurality of entries, the first entry structure including a first entry structure number and an flat-type connection component structure, and store a second entry structure of the plurality of entry structures, second entry structure including a second entry structure number and a flat-type connection component structure, wherein the second entry structure flat-type connection component structure includes the first entry structure number indicating the second entry structure has a flat hierarchical relationship to the first entry structure, and wherein the first entry structure flat-type connection component structure includes the second entry structure number indicating the first entry structure has a flat hierarchical connection to the second entry structure. In another aspect, the one of more processors are configured to execute the processor-executable instructions to store a first entry structure of the plurality of entry structures, the first entry structure including a first entry structure number and a custom-type connection component structure, wherein the custom-type connection component structure including an entry structure number of a second entry indicating that the first entry structure has a connection to the second entry, the custom-type connection component structure further comprising a reference designator representative of the connection between the first entry structure and the second entry structure.

In another aspect, the transaction includes populating a first entry structure of the plurality of entry structures, wherein populating the first entry structure includes generating and storing an entry structure keyword list of the first entry structure (which may be referred to herein and in the Figures as “Fast Find”), generating and storing an entry structure size of the first entry structure (e.g., in bytes), generating and storing an entry structure number of the first entry structure, generating and storing a status of the first entry structure, determining the number of component structures for the first entry structure and storing the number of component structure in the first entry structure, and generating and storing data in component structures of the first entry structure.

In another aspect, the one or more non-transitory computer storage mediums include at least two non-transitory computer storage mediums, and wherein the at least two non-transitory computer storage mediums include a solid-state drive, wherein the plurality of entry structures are stored on the first memory component structure. In another aspect, the at least at least two non-transitory computer storage mediums include one or more solid state memory chips, wherein the processor-executable instructions to operate the database engine are stored on the second memory drive.

Another innovation includes a method for storing and retrieving data in a computer system having one or more non-transitory memory components and one or more computer processors. Embodiments of such methods can include configuring the one or more computer memory components according to a plurality of logical entry structures, each entry structure including (i) an entry name, (ii) an entry structure keyword list, (iii) an entry structure size, (iv) a unique entry structure number, (v) a status of the entry structure, (vi) a total number of component structures in the entry structure, each entry structure having one or more component structures, and (vii) the component structures in the respective entry structure. Each of the component structures in a respective entry structure can include (i) a component structure name, (ii) a component structure type, and (iii) component data content, each component structure being contained in only one entry structure, wherein each respective component structure in an entry structure defined as one of a numeric data type, a text data type, a date data type, or a connection data type, and wherein each connection data type component structure including an entry structure number indicating an entry structure having a hierarchical connection to the respective entry structure.

Another innovation includes a method for storing and retrieving data in a computer system having one or more non-transitory memory components and one or more computer processors. Embodiments of such methods can include configuring the one or more computer memory components according to a plurality of logical entry structures, each entry structure including a unique entry structure number, and the component structures in the respective entry structure, each of the component structures in a respective entry structure including (i) a component structure name, (ii) a component structure type, and (iii) component data content, each component structure being contained in only one entry structure, wherein each respective component structure in an entry structure is one of a numeric data type, a text data type, a date data type, or a connection data type, and wherein each connection data type component structure includes an entry structure number indicating an entry structure having a hierarchical connection to the respective entry structure, and populating the plurality of entry structures with data content, where the component structure type is generated based on the data content as the data content is processed to populate the plurality of entry structures.

Another innovation includes a method for storing and retrieving data in a computer system having one or more non-transitory memory components and one or more computer processors. Embodiments of such methods can include configuring the one or more computer memory components according to a plurality of logical entry structures, each entry structure including a unique entry structure number, and the component structures in the respective entry structure, each of the component structures in a respective entry structure including (i) a component structure name, (ii) a component structure type, and (iii) component data content, each component structure being contained in only one entry structure, wherein each respective component structure in an entry structure is one of a numeric data type, a text data type, a date data type, or a connection data type, and wherein each connection data type component structure includes an entry structure number indicating an entry structure having a hierarchical connection to the respective entry structure. Such methods may also include populating the plurality of entry structures with data content, where the component structure type is generated based on the data content as the data content is processed to populate the plurality of entry structures. Embodiments of methods can include adding a first connection data type component structure to an existing first entry structure, the first connection data type component structure including the entry number corresponding to the entry number of an existing entry structure. Embodiments of methods can further include adding a new entry structure, the new entry structure including a first connection data type component structure having an entry number corresponding to an existing entry structure.

Various embodiments of the present disclosure are inextricably tied to improvements in computer technology. The embodiments of the Entry/Component structures allow the structures to grow, or to shrink, with every entry, if needed to store data content. While some NoSQL databases may require limited definitions to store data content, such databases still require some predetermined data content-related documents or structures to be defined and/or some pre-planning of relationships and data structures to be predetermined. As an example of the Entry/Component structures described herein, certain data content can be stored in 1001 (or more) different Entry/component structures (i.e., including corresponding Component structures of the Entry structure), where each of the Entry/Component structures may be structured differently. That is, Entry/Component structure can actually have a different defined structure for storing the data content, the defined structure not being predetermined but instead being determined as the data content is being stored. The structures of any of the 1001 different Entry/Component structures can be revised at any time, and any desired connections between Entry structures can be defined/revised at any time. As described herein, existing data storage and processing technology is limited in various ways (e.g., predetermined schema and tables are needed, inflexibility in revising data structures, unable to change the type, size, or connections between storage structures on the fly) and various embodiments of the disclosure provide significant improvements over such technology. Such features and others (e.g., processing, storing, and retrieving large amounts of electronic data) are intimately tied to, and enabled by, computer technology, and would not exist except for computer technology. For example, the interactions and operations with data described herein in reference to various embodiments cannot reasonably be performed by humans alone, without the computer technology upon which they are implemented.

Additional embodiments of the disclosure are described below in reference to the appended claims, which may serve as an additional summary of the disclosure. In various embodiments, systems and/or computer systems are disclosed that comprise one or more non-transitory computer readable storage medium having program instructions embodied therewith, and one or more processors configured to execute the program instructions to cause the one or more processors to perform operations comprising one or more aspects of the above- and/or below-described embodiments (including one or more aspects of the appended claims).

In various embodiments, computer-implemented methods are disclosed in which, by one or more processors executing program instructions, one or more aspects of the above- and/or below-described embodiments (including one or more aspects of the appended claims) are implemented and/or performed.

### BRIEF DESCRIPTION OF THE DRAWINGS

FIG. 1A illustrates an example of a computer system that includes a database engine described herein.

FIG. 1B illustrates an example of a database structure, in accordance with embodiments described herein.

FIG. 2 is a diagram that illustrates an example of Entry/Component entity relationship, according to some embodiments.

FIG. 3 illustrates a computer system with which certain methods discussed herein may be implemented.

FIG. 4A illustrates an example of the database engine file architecture.

FIG. 4B illustrates an example of a plurality of unpopulated Entry structures.

FIG. 4C illustrates an example of a plurality of Entry structures that are populated, showing an example of the disparate data size, data type, content, connections, and data structure of the Entry structures is possible with the disclosed logical structures.

FIG. 5 is a flowchart illustrating an example of a method for creating a file.

FIGS. 6A, 6B, and 6C are flowcharts illustrating examples of a method for searching for an entry. Specifically, FIG. 6A illustrates a process to populate the lower search and upper Search Entries, which sets up the Search Entries to use as Search Vectors. FIG. 6B illustrates a process for Searching the Universe for Entries with specific values, which is the process called when the user wants to Search the Universe for Entries with specific values. FIG. 6C illustrates a process for a Fast-Find Search that allows finding Entries faster by searching only a text field near the top of each Entry.

FIGS. 7A and 7B illustrate methods for adding connection components and Entries. Specifically, FIG. 7A is a flowchart illustrating an example of a method that creates and populates a new Entry and adds the new Entry to the Universe. FIG. 7B is a flowchart illustrating an example of a method for a Propagated Add Operation, showing to add Connection Components the respective Connected Entries must be modified to include the corresponding Reciprocal Connection Components.

FIGS. 8A, 8B, and 8C show methods of deleting an Entry. FIG. 8A is a flowchart illustrating an example of a method for deleting an entry form a database, sometimes referred to as Main Entry Delete. This is a process called when the user wants to delete an Entry.

FIG. 8B illustrates an example of a method of Propagated Entry Delete, which can delete an Entry and all references to the Entry in the respective Connected Entries. FIG. 8C illustrates an example of a method that deletes an Entry with no regard to Connected Entries.

FIGS. 9A and 9B are flowcharts illustrating examples of methods for editing an Entry in a database. For example, FIG. 9A is a flowchart illustrating an example of a method for editing an Entry in a database where deleting the entry includes deleting an Entry by the Main Entry Delete process including Propagated Entry Delete. FIG. 9B is a flowchart illustrating an example of a method for editing an Entry by replacing the Entry (“Entry Replace”) which can be used when the user want to replace an Entry.

FIG. 10 is a flowchart illustrating an example of a method for the operation to “explode” an Entry. (Explosion query operation.)

FIG. 11 is a flowchart illustrating an example of a method for the operation to “implode” an Entry. (Implosion query operation.)

FIG. 12 is a flowchart illustrating an example of a method for a flat-connection query operation.

FIG. 13 is a flowchart illustrating an example of a method for a custom-connection query operation.

FIG. 14 is a flowchart illustrating an example of a method for importing information from csv files (e.g., from spreadsheets, database tables, etc.) the operation to “explode” an entry.

FIG. 15 is a flowchart illustrating an example of a method for exporting information to csv files (e.g., for spreadsheets, database tables, etc.)

FIG. 16 is a flowchart illustrating an example of a method for viewing deleted entries.

FIG. 17 is a flowchart illustrating an example of a method for a defragmentation operation, e.g., to purge deleted entries.

### DETAILED DESCRIPTION OF CERTAIN INVENTIVE ASPECTS

The detailed description of various exemplary embodiments below, in relation to the drawings, is intended as a description of various aspects of the various exemplary embodiments of the present invention and is not intended to represent the only aspects in which the various exemplary embodiments described herein may be practiced. The detailed description includes specific details for the purpose of providing a thorough understanding of the various exemplary embodiments of the present invention. However, it will be apparent to those skilled in the art that some aspects of the various exemplary embodiments of the present invention may be practiced without these specific details. In some instances, well-known structures and components are shown in block diagram form in order to avoid obscuring various examples of various embodiments.

Although particular aspects various exemplary embodiments are described herein, numerous variations, combinations and permutations of these aspects fall within the scope of the disclosure. Although some benefits and advantages of certain aspects are mentioned, the scope of the disclosure is not intended to be limited to particular benefits, uses or objectives.

### Overview

This document details a new database engine that includes core feature that improve computing technologies, in particular database and database engine technologies. Such features include the ability for the database engine to simply and automatically enter disparate or amorphous data in a single, large data storage area. The database engine can relate disparate or amorphous data entries to each other in a hierarchical, flat, or custom-defined relationship as a core, native (built-in) function of the database engine without needing programming languages or special, complex data documents. The database engine stores data in a single storage area (e.g., a database file on a non-transitory computer medium) structured a plurality of Entries that provides capability that no other database file includes and, for many applications, provides an improvement to database and computer functionality. Each Entry includes Components of the type numeric, text, date, or connection. A Component of type connection stores connection information to another Entry. Predefining data storage structures (e.g., data objects) is not needed as the connection data is handled merely as another type of data in the Component (e.g., connection data in a connection Component). In some embodiments, the flexible Entry data structure (e.g., implemented as nested structures and unions in C++ or an object-oriented abstract class structure in C#) facilitates the possible addition of other data types in a streamlined manner without application disruption. For example, some embodiments may include a binary data type (e.g., binary files) for storage of images, etc.

This native capability allows data to be entered immediately with little or no preplanning or complex software knowledge. For example, a database engine implementing this database eliminates the need to create a database schema (and corresponding up-front data modeling) as required before using a relational database, or a no-SQL database. In other words, the database engine can input data and define relationships as indicated by a user as the data is being entered, or at any time subsequently. In operation, the database engine can start entering the data and the relationships between the data, and the database schema will evolve within the database naturally over time as the database is populated and the relationships between data entries are established or modified, hence facilitating the natural growth of a dynamic schema. That is, a “schema” will evolve (or become apparent) based on the connections between the data, instead of defining a schema beforehand and then entering data based on the schema. This results in an optimized schema, inherent simplicity, and a fast-learning curve. A database engine can store data in the described structure such that each Entry can be referential to another Entry in a parent, child, or sibling (e.g., flat) hierarchy, and this referential relationship can be changed at any time, and it does not need to be predefined.

The structures of a database generated by the database engine as described herein has many advantages. The database is self-referential in that any Entry can include a connection Component referencing any other Entry in a flat or hierarchical structure, and without any predefined relational tables, object structures, or ontology defining such relationships. In addition, the logical structures defined by the database engine forms a multiple self-referential database such that any Entry can reference multiple other Entries indicating different hierarchical structures, and again without any predefined relational tables, object structures, or ontology defining such relationships. The relationships can be revised, added, or deleted at any time without changing a schema or object definitions. Also, the logical structures defined by the database engine forms a de-coupled self-referential database, where the Entry # that is used for referencing other Entries and associated Components is de-coupled from the data type of it's Components, such that any Entry of with one or more Components of any data type can reference any other Entry (or multiple Entries) with Components of any other data type. This can allow the database engine to form logical structures in database of undefined form and connections. For example, to store information of a “BOY” Entry referencing a “BICYCLE” Entry (indicting via a hierarchical connection Component ownership of the BICYCLE by the BOY, a “GIFT” Entry having a date Component and a connection Component to reference both the BOY Entry and the BICYCLE Entry (indicating for example, when the bike was given to the boy), a “Maintenance” Entry having a date Component and a connection Component referencing the BICYCLE Entry (indicating for example when that bicycle needs maintenance), and a “ADDRESS” Entry having a text Component indicting the address of the boy and having a connection Component referencing the BOY Entry (indicating the boy's home address). All of these connections can be defined as the data is being processed for storage in the database, added later, deleted later, and/or revised later without having to change any relational tables, re-define object structures, or change an ontology defining objects and associations that are stored in a database.

Relationships (or connections) between the data can be entered or modified at any time, during or after data entry. This database supports many-to-many, one-to-one, one-to-many, many-to-one, or no relationships.

Applications include Graph Databases, Colored Petri Nets (“CP-nets” or “CPN”), event-store databases (customer interactions, project task tracking, and similar), multi-level bill-of-materials, object-oriented data modeling and database, vast sparse matrix data sets, machine learning, and anywhere else that disparate or amorphous data needs to be quickly and easily related in a wide variety of different types of relationships without requiring complicated programming and data documents.

This database engine can also readily store more conventional data sets as customarily implemented in relational databases, but its greatest advantage is the quick and easy storing of disparate or amorphous types of data with a wide variety of different types of relationships between this disparate or amorphous data.

Every Entry in this database is simply placed in a single area called the “Universe”, unlike other databases (MySQL, MariaDB, MongoDB, et. al.) in which data is placed in complex combinations of multiple Tables, Collections, and the like. this database is essentially “language-less” with a fast-learning curve, since it does not require complex query languages or specialized data documents (JSON, XML) to store or access (query) data, such as SQL for relational databases, such as MySQL or MariaDB, or the hard-to-read and complicated JSON/Javascript approach as done with no-SQL (or nosql) databases, such as MongoDB and CouchDB. Hence, embodiments of the database can be thought of as both nosql and “no nosql” (abbreviated herein as no′sql), since it uses neither sql nor the typical nosql JSON/Javascript approach. This database does not require (or use) complex, specialized graph query languages such as Apache TinkerPop or W3C SPARQL for Graph Database implementation, such as used in Amazon Neptune.

In various embodiments, an API may be used for this database to enable access to the database engine from other programs, the command line, or a GUI. In some embodiments, such a language could be developed for this database. In such embodiments, the unique underlying structure of this database engine facilitates embodiments of an API or language where the API or language and functionality is clear and efficient. A simple, intuitive language, if desired in some embodiments.

### Terms

In order to facilitate an understanding of the systems and methods discussed herein, a number of terms are defined below. The terms defined below, as well as other terms used herein, should be construed to include the provided definitions, the ordinary and customary meaning of the terms, and/or any other implied meaning for the respective terms. Thus, the definitions below do not limit the meaning of these terms, but only provide exemplary definitions.

API: Acronym for Application Programming Interface, as typically used in software engineering.

ACID: Atomicity, Consistency, Isolation, and Durability—transactions in a relational database are typically ACID-compliant.

Add Entry, Propagated. See Propagated Entry Add.

Client: As used in this document, refers to the user of this database.

Column: this means a “column” as typically referred to in a relational database, such that a relational database table consists of “rows” and “columns.”

Complementary Component: Same as Reciprocal Connection Component.

Component: The most elementary unit of data in this database. Components make up an Entry, which is the basic data item stored and retrieved in this database. A Component can be one of 4 types of data: text, numeric, date, and also a special 4th type of Component called a Connection Component, which is detailed in the discussion in this document.

Connection: refers to a relationship made between 2 Entries in the database. The word “connection” is used in this document to avoid confusion with relational database technology.

Connected Entry: the entry to which a Connection Component points.

Connection Entry: Alternate term for Connected Entry.

CRUD: Acronym for Create, Read, Update, and Delete operations as commonly used with database technology.

Custom-Connection: a custom-defined connection. Can be created with a Custom-Connection Component.

Custom-Connection Component: Used to establish a custom, user-defined connection between Entries (as detailed in elsewhere in this document).

Custom-Connection Entry Number: Entry Number of the Entry to which a Custom-Connection Component in an Entry connects (points) per the custom connection.

Custom-Track Component: Alternate term for Custom-Connection Component.

Custom-Track Connection: Alternate term for Custom Connection.

Database Engine: A database engine is the underlying system that a database uses to function, for example, the part of a database system that actually stores and retrieves data. A database engine can be implemented, for example, using one or more processors, on standalone computer systems, on networked systems, on server systems, and/or on cloud-based system.

dbe: Abbreviation for “database engine.”

Delete Entry, Propagated. See Propagated Entry Delete.

DVIS: Database Version Information String. The DVIS is a text string in the database file that is used by the database engine to determine the specific version of the database file, so that the database file can be run correctly by the database engine.

Entry: The basic data item in this database. It is the unit of data that is stored and retrieved in this database. An Entry is made up of Components, which is the most primitive data item in embodiments of the database.

Explode: The act of querying an Entry for all Entries that have a subordinate hierarchical relationship to the Entry. “Explode” is the opposite of “Implode.”

Explosion Component: Also called “Explode-Connection Component.” Used to establish a subordinate hierarchical connection between Entries (as detailed elsewhere in this disclosure).

Explosion Entry Number: Entry Number of the Entry to which an Explosion Component in an Entry Explodes.

Field: same as “column” as referred to in relational database terminology.

Flat: A non-hierarchical connection between Entries. Can be created with a Flat Component. Also called Flat Connection.

Flat Component: Also called “Flat-Connection Component.” Used to establish a “flat” (non-hierarchical) connection between Entries (as described in elsewhere in this document).

Flat-Connection Entry Number: Entry Number of the Entry to which a Flat Connection Component in an Entry (non-hierarchically) connects (points).

Flat-Track Component: Alternate term for Flat Component.

Flat-Track Connection: Alternate term for Flat (as defined herein).

GUI: Acronym for Graphical User Interface, as commonly used in software engineering.

Implode: The act of querying an Entry for all Entries that have a superordinate hierarchical relationship to the Entry. “Implode” is the opposite of “Explode.”

Implosion Component: Also called “Implode-Connection Component.” Used to establish a superordinate hierarchical connection between Entries (as described elsewhere in this disclosure).

Implosion Entry Number: Entry Number of the Entry to which an Implosion Component in an Entry Implodes (i.e., points to).

i/o: Abbreviation for “input-output.”

metadata: As used in this document means any data beyond the data that is stored by the client (user). This data is used to facilitate functioning of the database engine, and other support functions.

no²sql: Refers to this database invention being “no nosql”, meaning that it uses neither sql nor the typical nosql JSON/Javascript approach. Using no′sql as a shorthand for “no nosql.”

n/a: “not applicable.”

Opposite Component: the Reciprocal Connection Component for a given Connection Component; specifically, an Implode Component is the Opposite of an Explode Component, an Explode Component is the Opposite of an Implode Component, a Flat-Track Component is the Opposite of another Flat-Track Component (since hierarchically-equivalent, on same level), and a Custom-Track Component is the Opposite of a user-defined corresponding Custom-Track Reciprocal Connection Component, if the user created one (which is optional).

Origin Entry: The Entry containing a Connection Component when referenced with respect to the Entry (Connected Entry) to which its Connection Component points.

Point: Refers to looking at a Connected Entry as referenced by its Entry Number in a Connection Component in the Origin Entry.

Propagated Entry Add: When an Entry is added and simultaneously all Entries pointed to (Entries to be Connected) by the Entry Connection Components are modified by adding the respective Reciprocal Connection Components to each respective Entry to be Connected. This effectively implements the Entry Connections. Hence, in addition to creating a new Entry, all Entries to be connected are simultaneously modified and re-written with the Reciprocal Connection Components added. This is done automatically by the database engine.

Propagated Entry Delete: When an Entry is deleted and simultaneously all Entries pointed to (Connected Entries) by the Entry Connection Components are modified by deleting the respective Reciprocal Connection Components is all of the Connected Entries. This effectively breaks the Entry Connections. Hence, in addition to deleting the Entry, all Connected Entries are simultaneously modified and re-written with the respective Reciprocal Connection Components deleted. This is done automatically by the database engine.

RAID: “Redundant Array of Independent Disks.” A scheme to store data across multiple physical disks.

Reciprocal Connection Component: the corresponding Connection Component in the Connected Entry; for example, an Explode Component will have a corresponding Implode Component in the respective Connected Entry.

Record: same as “row” as referred to in relational database terminology.

Relationship: refers to a relationship made between 2 Entries in the database. The word “connection” is often used in this document to avoid confusion with relational database technology.

Row: this means a “row” as typically referred to in a relational database, such that a relational database table consists of “rows” and “columns”. This is sometimes also called a “tuple.” Analogous to a “document” in nosql MongoDB.

SEL: Search Entry Lower. The Entry Number lower search bound (if searched), the Entry Name (if searched), and the lower range search values are placed in the respective Components of this Entry.

SEU: Search Entry Upper. The Entry Number upper search bound (if searched) and the upper range search values are placed in the respective Components of this Entry.

Sharding: A way to partition a database typically across multiple servers.

Schema: “schema” as used in this disclosure generally refers to a predetermined organization of a database structure for storing information, e.g., a graphical depiction or physical model of a database structure or text that describes the organization of data in a language that can be interpreted by a database. For example, when considered in graphical format of one or more tables, a schema may predetermine (or pre-define) a set of the tables such that each of the tables have certain rows and columns. For example, a database of “People in a City” may include a first predefined table where each row is a different person, and each of the column entries for a row is a characteristic associated with a certain person such as first name, middle name, last name, home address, age, profession, etc. (e.g., the headers for the column are first name, middle name, last name, home address, age, SSN, profession, etc.). The “People in a City” table may have a link to another table that includes information associated with the persons in the “People in the City” table, for example, a “DMV Information” table that that includes rows of people, each row including a first name, last name, SSN, first vehicle, second vehicle, third vehicle, etc. The schema may predefine the link between the “DMV Information” table and the “People in the City” table to be the SSN column information. In this disclosure, the term “schema-less” may be used to describe some databases. However, the term “schema-less” does not mean that the data stored in these databases is unstructured or unorganized. Rather the term is used to refer to the fact that the databases do not adhere to a strict uniform, normalized structure and may include a number of lower-level organizational structures for data. Also, a schema-less databases may be referred to as non-relational databases since a relational data model is not used.

Table: In a relational database a Table is typically a set of rows and columns similar in appearance to a spreadsheet, and it usually contains information related to a certain subject. A Table is analogous to a “Collection” in nosql MongoDB.

Transaction: a group of tasks performed on a database for data retrieval, storage, or updates. In most relational databases, transactions should be ACID (which see herein).

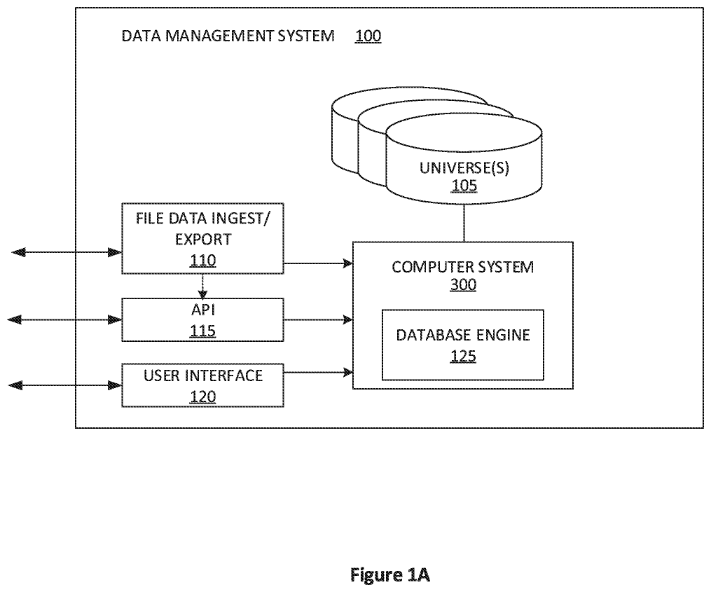

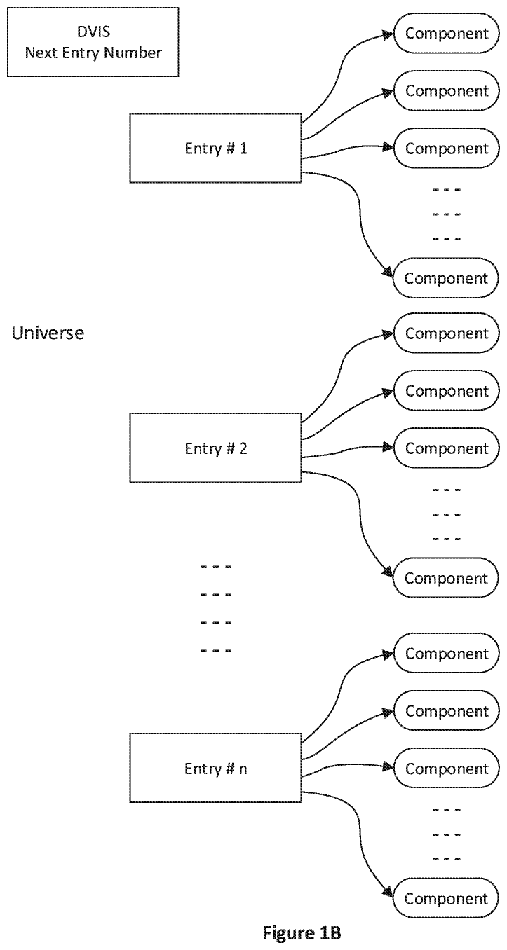

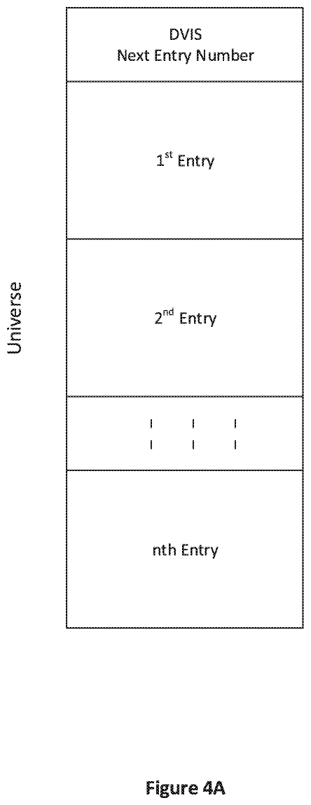

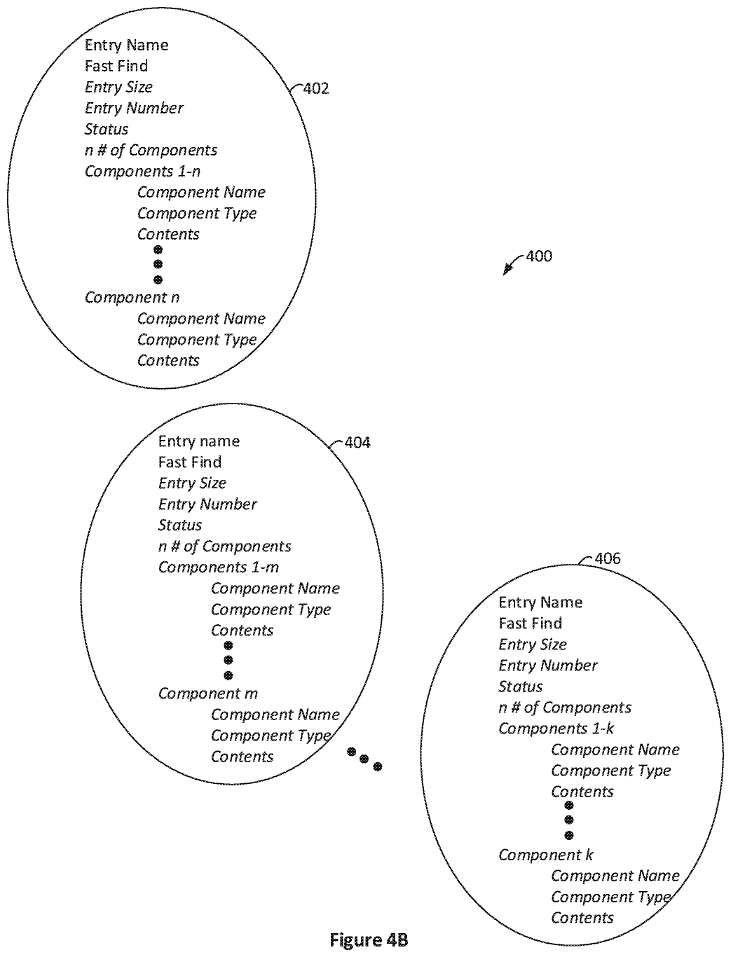

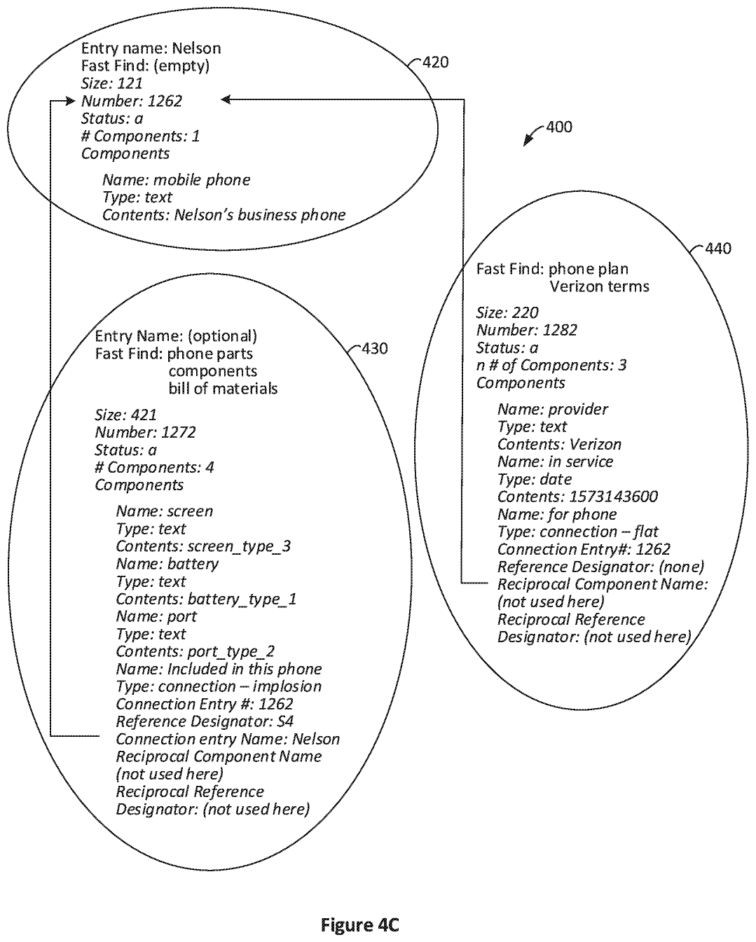

Universe: a single logical container that contains all data and data entities in this database; as such, it is coincident with the database file, and is the largest entity in this database. See FIGS. 1B and 4A. This database file may reside on a single volume (disk), a RAID (multiple) disk system, a physical server, VPS server, cloud storage, or sharded over multiple servers. Hence, although the Universe is a single logical container, it may be implemented using multiple physical devices.

VPS: Virtual Private Server

### Illustrative Example of a Database Engine

Described below is an illustrative example of a database engine. Other examples of such database engines using some, or all, of the described technology are also possible.

FIG. 1A illustrates an example of a data management system 100. The data management system 100 can include a computer system 300 that includes a database engine 125 that implements functionality related to configuring one or more non-transitory computer memory components according to a plurality of Entry structures and Component structures for storing data content on non-transitory computer storage medium in a Universe 105, as described herein. In some embodiments, the illustrated data management system 100 can receive data for storage in one or more ways.

In some embodiments, the data management system 100 can include an application programming interface (API) 115 that allows another system to electronically interface with the computer system 300 that contains the database engine 125 to perform database functionality (e.g., stored data, retrieve data, search for data, revised stored data, etc.).

In some embodiments, the data management system 100 can receive, or provide, data content in one or more files as illustrated by the file data ingest/export block 110. Such a file may be in various formats including a comma separated value file (cvs). In various embodiments, such files may be communicated to the computer system 300, or they may be communicated to the computer system 300 indirectly via the API 115.

In some embodiments, the data management system 100 can include a user interface 120 that allows a user to directly enter data to be processed by the database engine 125. The user interface 120 may include, for example, a display screen, a keyboard, and/or a pointing device (such as a mouse).

In some embodiments, the data management system 100 can be configured as a standalone system operating on one or more computer processors. In some embodiments the data management system 100 can be configured as a cloud-based system where the data management system 100 in the database engine 125 are operating in the remote location on one or more servers, and a client-side application accesses the data management system 100 via a network connection (e.g., LAN, the Internet or the “cloud”). Various other configurations of the data management system 100 are also possible.

FIG. 1B illustrates an example of a database structure (“database”) that is implemented by the database engine, in accordance with embodiments described herein. As a high-level description of certain embodiments, a database implemented by the database engine (dbe) includes data Entries (or Entry structures) placed in a single large container referred to herein as the “Universe.” In some embodiments, a data management system can have numerous different (e.g., completely unrelated) data sets stored in a plurality of different Universes. A non-transitory memory component (memory chips, a rotatable hard drive, SSD) can be configured by the system to store the Universe. The Universe can be a single file (e.g., a database file) configured by a database engine (dbe) to operate as described herein. Accordingly, in this example, the “Universe” for storing a set of data is coincident with the database file generated for storing the set of data. Each data Entry includes one or more Components of data. The Components are the “building blocks” of an Entry, and Components are the most elementary unit of data used in this database. Each Entry is uniquely identified with an Entry number, and the Universe stores the next available Entry Number (“Next Entry Number”) that will be assigned to the next new Entry. In some embodiments, a Database Version Information String (DVIS) can be included, e.g., before the Entry Number. The DVIS is a text string in the database file that is used by the database engine to determine the specific version of the database file, so that it can be run correctly by the database engine. Newer, various, or custom versions of the database engine may require changes to the database file structure, for example, to improve performance, lower cost, increase reliability, or add, subtract, or modify features; hence, when the database engine first reads a database file, it must first read this DVIS to determine specifically which version of database file it is working with in order to “know” how to correctly use (read, write, and modify) the database file. As mentioned above, the DVIS can be implemented as a variable-length text string placed as the first item (at the “top”) of the database file, replacing the Next Entry Number as the first item in the database file, since the database engine must know the database file version before doing any further processing. The Next Entry Number is moved after DVIS, as the second item in the database file. In an example, DVIS is implemented as a variable-length string, e.g., specifically, in C++ it is initially implemented as: unsigned short dvis_text_length; // (Used with the text pointer below.) char*dvis_text_pointer;

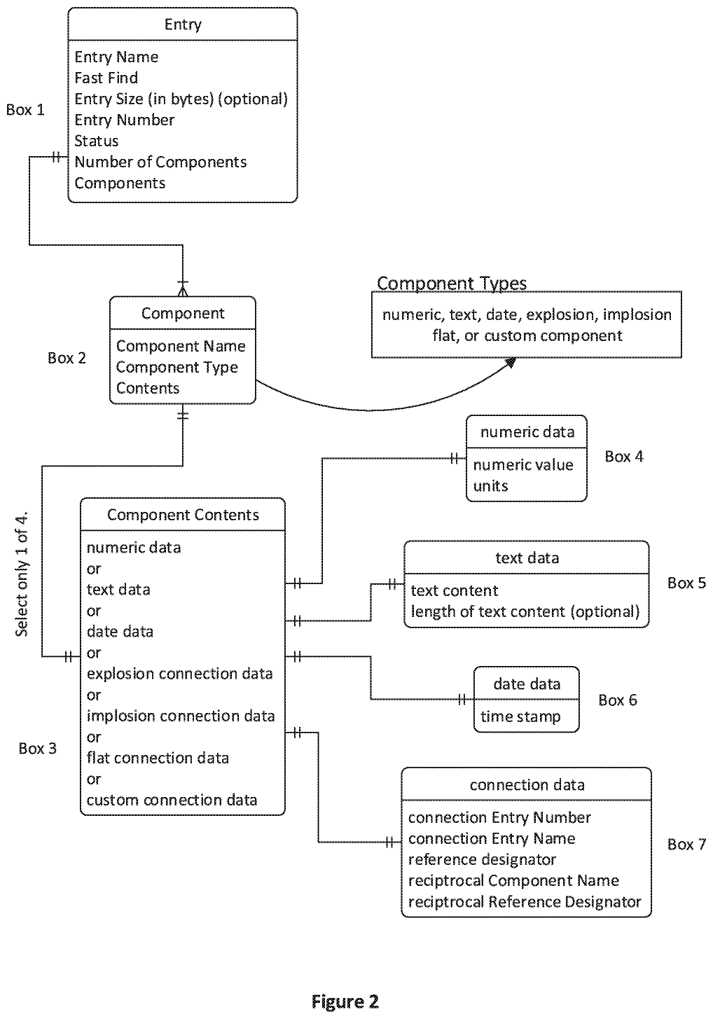

There are four different types of Components corresponding to four different types of data: numeric data, text data, date data, and connection data. Examples of these Components are illustrated in FIG. 2 in box 4 (numeric data Component), box 5 (text data Component), box 6 (date data Component), and box 7 (connection data Component). The numeric Components store numbers, text Components store textual data, and date components store a date. These data types may be stored in alternate representations in different embodiments. For example, the date may be stored as the Unix timestamp in some embodiments, or in another representation of the date, such as month/day/year or ticks (e.g., 100 nanoseconds) such as done with .NET. Numbers may be stored in a variety of ways; for example, integer, double precision, or long decimal (like the “decimal” type in the C# programming language). The connection Components, illustrated in boxes 3 and 7 (FIG. 2) are a special type of data in this database, and they are used to establish the relationships between the data Entries. Relationships between data, as used herein, are often referred to as “connections” instead of “relationships” or “relations” to avoid confusion between the embodiments of this database described herein and relational database technology.

There are four types of connection Components: Explosion, Implosion, Flat, and Custom. An Explosion Component establishes a subordinate hierarchical connection (relationship) of another Entry to the Entry in which the Explosion Component is contained. For example, if an Explosion Component is a component of Entry Number 95651, and the Explosion Component includes the connection Entry Number 95850, then Entry Number 95850 has a subordinate hierarchical connection to Entry Number 95651. Note, for ease of reference, “Entry Number” is sometimes referred to herein as “Entry #”, or simply “Entry” or “Entries”. In another example, if three Explosion Components are components of Entry Number 95651, and a first of the three Explosion Components includes the connection Entry Number 95850, a second of the three Explosion Components includes the connection Entry Number 95855, and a third of the three Explosion Components includes the connection Entry Number 95860, then Entry Number 95651 is understood to have a connection to “explode” to Entry Numbers 95850, 95855, and 95860 such that Entry Numbers 95850, 95855, and 95860 each have a subordinate hierarchical connection with Entry Number 95651. In some instances, an Entry may include more than one Explosion Component, or no Explosion Components. In some embodiments, multiple Entries can have connection Components that indicate a multi-tier hierarchical relationship (e.g., 3-tier, 4-tier, . . . n-tier). For example, where Entry Number 95850 explodes to Entry Number 95855, and Entry Number 95855 explodes to Entry Number 95860. In another example, Entry Number 95850 implodes to Entry Number 95855, and Entry Number 95855 implodes to Entry Number 95860. In another example, Entry Number 95850 implodes to Entry Number 95855, and Entry Number 95855 implodes to Entry Number 95860, Entry Number 95860 has a flat connection with Entry Number 95865, and Entry Number 95865 explodes to Entry Number 95832. Other combinations of hierarchies that utilize one or more of the explosion, implosion, of flat connection Components are also possible.

Conversely, an Implosion Component establishes a superordinate hierarchical connection (relationship) of another Entry to the Entry in which the Implosion Component is contained. For example, if an Implosion Component is a component of Entry Number 95651, and the Implosion Component includes the connection Entry Number 95850, then Entry Number 95850 has a superordinate hierarchical connection to Entry Number 95651. In another example, if three Implosion Components are components of Entry Number 95651, and a first of the three Implosion Components includes the connection Entry Number 95850, a second of the three Implosion Components includes the connection Entry Number 95855, and a third of the three Implosion Components includes the connection Entry Number 95860, then Entries 95850, 95855, and 95860 is understood to have a connection to “implode” to Entry Number 95651 such that Entry Numbers 95850, 95855, and 95860 each have a superordinate hierarchical connection with Entry Number 95651. In some instances, an Entry may include more than one Implosion Components, or no Implosion Components.

A Flat Component establishes a “flat” (non-hierarchical, at the same level) connection between another Entry and the Entry in which the Flat Component is contained. For example, if a Flat Component is a component of Entry Number 95651, and the Flat Component includes the connection Entry Number 95850, then Entry Number 95850 has a non-hierarchical connection to Entry Number 95651. In some instances, an Entry may include more than one Flat Components, or no Flat Components.

A Custom-Connection Component establishes a custom-defined relationship between the Entry in which it is contained and another Entry. In some instances, an Entry may include more than one Custom-Connection Components, or no Custom-Connection Components.

In various embodiments, Connections between the data can be entered or modified at any time, during or after data entry. In various embodiments, the Connections between Entries can be one way, two way, many-to-many, one-to-one, one-to-many, many-to-one, or no connections.

Each Connection Component establishes the connection (relationship) between the Entry that contains it and the connected (related) Entry by containing the Entry Number of the connected (related) Entry; for example, if Entry #1262 represents a smart phone and Entry #1199 represents the smart phone's touch screen, we may want to establish a relationship with Entry #1199 (touch screen) being subordinate to Entry #1262 (the smart phone) to represent that the touch screen is a part of the smart phone. To do this, we would include an Explosion Component in the smart phone Entry (Entry #1262), and this Explosion Component would contain Entry #1199 (the touch screen) as an Entry to which Entry #1262 (the smart phone) “explodes” to establish that the touch screen is subordinate to the smart phone. At the same time, the database engine will automatically place an Implosion Component in Entry #1199 (the touch screen) that contains Entry #1262 (the smart phone) as the Entry to which Entry #1199 “implodes” to establish that the smart phone is superordinate to the touch screen. A similar process can occur with the other Connection Components. Also, in various embodiments, there can be variations on this process, as described herein.

In some embodiments, all of the Connection Component above-described four types of connection Components (Explosion, Implosion, Flat, and Custom) are not used. In some embodiments, the Custom Component is not used. In some embodiments only an Explosion component may be used. For example, because of the symmetry between an Explosion component and an Implosion component (If Entry A explodes to Entry B, then Entry B implodes to Entry A), by including the Explosion component in a particular Entry, the relationship can be sufficiently indicated. Also, a Flat connection can be shown by including an Explosion component in each of the connected Entries, and the database engine being configured recognize that a Flat connection exists when two Entries each have an Explosion Component referencing to Explode to the other Entry. Similarly, in some embodiments only an Implosion Component can be used. By including the Implosion component in a particular Entry of the connected Entries, the Implosion relationship can be sufficiently indicated. Also, a Flat connection could be shown by including an Implosion component in each of the connected Entries, and the database engine being configured recognize that a Flat connection exists when two Entries each have an Implosion Component referencing to Implode to the other Entry.

The database engine automatically creates a Reciprocal Connection Component in the respective Connected Entry for Explode, Implode, and Flat-Track Connection Components; for example, when an Explode Component is created, the database engine automatically goes to the Entry to which the Explode Component points (the Connected Entry) and creates a corresponding Implode Component in that Connected Entry; hence, this corresponding Implode Component in the Connected Entry is the Reciprocal Connection Component to the Explode Component in the Origin Entry. Likewise, when an Implode Component is created, the database engine automatically creates a corresponding Explode Component in the Entry to which the Implode Component points, and when a Flat-Track Connection Component is created, the database engine automatically creates a corresponding Flat-Track Component in the Entry to which the first Flat-Track Component points. That is, when an Explode, Implode, or Flat-Track Connection Component is created, the database engine automatically creates a corresponding opposite Connection Component in the respective Connected Entry. If the specified Connected Entry does not exist, the database engine will not create the Connection Component.

Unlike for the Explode, Implode, and Flat-Track Connection Components, when the user creates a Custom-Track Connection Component, the database engine does not automatically create a Reciprocal Connection Component; instead, it gives the user an option to create a corresponding Reciprocal Connection Component during the creation of the Custom-Track Connection Component because with a Custom-Track Connection Component, an opposite Connection Component (Reciprocal Connection Component) may not exist, and, if it exists, its type is user-defined. If the user chooses not to create a corresponding Reciprocal Connection Component, the database engine automatically creates a “hidden” Reciprocal Connection Component in the Connected Entry. This “hidden” Custom-Track Reciprocal Connection Component is created with no Connection Name (no Component Name, since Component Name holds the Connection Name for Custom-Track Connection Components), and it does not print out. The purpose of this automatic “hidden” Custom-Track Reciprocal Connection Component is so that if the Connected Entry is deleted, the database engine knows to go to the corresponding Origin Entry and delete the Custom-Track Component pointing to the Entry being deleted, hence avoiding an “orphaned” Custom-Track Connection Component. If the specified Connected Entry does not exist, the database engine will not create the Connection Component.

Accordingly, in various embodiments, all of the data entered (or contained) in an Entry is stored as one of these only four types of Components: numeric, text, date, or custom connection Components. And each Connection Component is one of the four types: Explosion, Implosion, Flat, or Custom-Connection (Custom-Track Connection). This unique structure that the database engine uses to store information provides the unique feature to simply and automatically enter disparate or amorphous data in a single, large data storage area, and relate these disparate or amorphous data entries to each other in a hierarchical, flat, or custom-defined relationship as a core, native (built-in) function of the database engine as desired by a user, without needing programming languages or special, complex data documents. A database engine operable to perform functionality described herein can enter data immediately with little or no preplanning or complex software knowledge, and no predetermined or pre-defined tables of any kind. Such a database engine is operable to store data in such a format (or structure) as described herein completely eliminates the need to create a database schema, define tables (e.g., relational tables), and do any corresponding up-front data modeling, as is required before using a relational database, and required to at least some extent prior to using a nosql database. Data can be received from a file or entered manually, and define any relationships between the data and the database schema will evolve within the database naturally over time as the database is populated and the relationships between data entries are established or modified, hence facilitating the natural growth of a dynamic schema.

Accordingly, according to certain embodiments, an Entry is the basic unit of data storage in this database; that is, data is stored and retrieved as Entries. The Component is the smallest unit of data in this database, and, as noted above, Components are the “building blocks” of Entries. The Components can be entered and stored in an Entry in any order; specifically, the database engine treats the Connection Components like any other Component (text, numeric, and date), and they are simply stored in an Entry mixed in with the other (text, numeric, and date) Components. In some embodiments, the database engine can perform a search on the Entries to find Connection Components associated with a respective Entry, or one or more Entries. For example, the database engine can search one or more Entries to determine Connection Components of a certain type, or having certain relational characteristics. In one example, the database engine can determine which Entries have Connection Components that indicate a two-tier hierarchical relationship (e.g., indicating an implosion or explosion connection). In another example, the database engine can determine which Entries have Connection Components that indicate any type of a multi-tier hierarchical. For example, where Entry #21 explodes to Entry #33, and where Entry #33 explodes to Entry #47. In some embodiments, the database engine can perform relational operations of the Connection Components. For example, Bill (Entry #1278) is Bob's (Entry #1191) boss. Also, Bob and Bill both live in the same neighborhood, and they are both members of the same neighborhood homeowner's association. Hence, Bill can be represented in a superordinate relationship to Bob as Bob's boss; that is, Entry #1278 explodes to Entry #1191. But Bill and Bob are also peers as members of the homeowner's association; therefore, Entry #1278 and Entry #1191 also have a Flat relationship to represent this membership. Therefore, Entry #1278 is >=Entry #1191 (hierarchically).

In some embodiments, the database engine performs Connection Components mathematical operations or logical operations. Continuing from the above example, if we want to find out if Bill has any known (by the database) relationship to Bob, and if EXP represents an Explosion relationship, FLT represents a Flat relationship, and OR represents the OR logical operation, then Entry #1278 EXP Entry #1191 OR Entry #1278 IMP Entry #1191 OR Entry #1278 FLT Entry #1191=Boolean TRUE, because Entry #1278 has both an Explosion and a Flat relationship to Entry #1191, and a query can be performed by the database engine to determine if this is TRUE. Continuing from the above example, if Entry #1278 Explodes to the Entry for every person in the Lee County C++ Programming Club, which is Entry #99442, then it can be computed that Entry 1278 Explodes to Entry 99442. For example, if Entries 993, 994, . . . , 1099 are all members of the Programming Club, then Entry 1278 EXP Entry #993+Entry #1278 EXP Entry #994+ . . . +Entry #1278 EXP Entry #1099=Entry #1278 EXP Entry #99442. Similarly, in some embodiments, similar operations can be performed by the database engine in relation to Venn diagrams and set theory.

FIG. 2 is a diagram that illustrates an example of entry/component entity relationships, and entry/component architecture details according to some embodiments. Box 1 illustrates an Entry implemented by the database engine 125 (FIG. 1A). Box 2 illustrates examples of components that can be implemented by the database engine 125. Box 3 illustrates aspects of the component contents. Boxes 4-7 illustrate aspects different types of components, e.g., numeric data (box 4), text data (box 5), date data (box 6), and connection data (box 7). The structures that the database engine can implement are further described below.

### Database Engine Structure

In FIG. 2, box 1 stores Entry metadata and a pointer to the Components. There is a box 2 in FIG. 2 for each of the Components, and this stores the Component's name, type, and a pointer to the Component's contents.

In FIG. 2, box 3 together with boxes 4-7 shows how information is stored for the each of the particular types of Components; for example, a numeric Component as called out in Box 3 stores a numeric value and its units (if any). Hence, for example, it may store 12 inches such that “12” is the numeric value and “inches” are the units. Likewise, for the other Components (text, date, and Connection). The unique Entry structure detailed in FIG. 2 automatically adjusts to store any of the 4 types of Components (and the four types of Connection Components).

### Data Structure as a Unique “Virtual Mechanism”

The unique, flexible, and scalable data structure detailed in FIG. 2 inherently adjusts to enable each data Entry to have a different number and type of data Components (disparate or amorphous data), and integrates relationship tracking in with the data to enable a wide variety of relationships to be readily made between this disparate or amorphous data, including hierarchical, flat, and custom-defined relationships.

This data structure as shown in FIG. 2 functions as a software “mechanism” analogous to a physical mechanism in its ability to adjust to a wide range of different sizes and types of data Entries and readily relate these data Entries in a wide variety of relationships with just this single, underlying, unique adjustable data structure.

As described herein, data structure in FIG. 2 and the related functionality of how it works shows such data structures effectively function as a “virtual mechanism” (analogous to a physical mechanism), adjusting its data types, size, and relationships on-the-fly to adapt to the data and how it is related. This facilitates not needing to learn or use complex programming languages or special data documents.

### Entry and Component Structure Detail

The Entry and Component structure is the “heart” of this database. All data is stored and retrieved using this structure. This Entry/Component structure automatically adjusts to the contents of each specific Entry to enable each Entry to have a different number and type of data (Components) as data is entered, and it also integrates relationship tracking as a special type of data. It is this native functionality that can eliminate or substantially reduce the need to create a database schema, and corresponding up-front data modeling. The dbe is operable to receive and store data that is manually entered, or the data can be received from a non-manual entry method, such as ingesting a data file. For example, a data file that contains the same type of data (entries) can be provided to the dbe, and the dbe can read in each portion of data and generate Entries that include Components storing the data. The dbe can determine what type of Component for each part of the data (e.g., text, numeric, date, or connection) and store the data in the database described herein. For example, the dbe described herein is operable to read a file that includes rows of data where each of the portions of data on a row are separated by an indicator (e.g., a comma, a semi-colon, a space, or another particular character) and store the data in a plurality of Entries each having one or more components, where each row of the file stores an Entry. However, in some embodiments, each export/import file can contain only one type of Entry. That is, Entries in a file (exported or imported) are the same type of Entries consisting of the same set of Components. Hence, the present embodiment uses a separate export operation for each type of Entry. However, another embodiment may include a feature in which different types of Entries can be exported in a single export operation such that the dbe will automatically simultaneously create multiple export files (csv or equivalent), one file for each type of Entry exported. The date may be stored as a Unix timestamp as shown in FIG. 2 or in “ticks” (1 tick=100 nanoseconds) as used in .NET, for example. In some embodiments, when date data is exported (e.g., to a csv file, the date may be stored in another format (e.g., mm/dd/yyyy). This enables the dbe to automatically identify the data as a date when reading in during an import operation. If the date is stored as a Unix timestamp in a csv file, it would be difficult or impossible to distinguish it from numeric data. In some embodiments, additional functionality can be included so that at a wide variety of Entries could be exported in a single export operation such that the export operation would automatically create multiple export files (csv or similar), one file for each type of Entry.

This Entry and Component structure is detailed in the FIG. 2 Entity Relationship Diagram. This particular Entity Relationship diagram deviates from convention to facilitate describing this novel database structure. This Entity Relationship Diagram is to be interpreted as described in this text.

FIG. 2 shows the following key features of the Entry and Component structure: Each Entry can have one or more Components, but each Component corresponds to only one Entry; Each Component must be one of four data types: numeric, text, date, or Connection; and each data type has only one type of Component; for example, text data is only in a text Component. However, each Component data type can have different forms; for example, numeric can have options for integer, float, and decimal.

Each type of Component has only one type of structure; for example, a numeric component must have a numeric value and units (FIG. 2), although the units do not have to be used. (Conversely, that structure is used for only that type of component.) To facilitate the following discussion, the boxes in FIG. 2 are labeled as Box 1, Box 2, etc.

### Entry Structures

Box 1 (FIG. 2) illustrates an embodiment where the Entry consists of seven parts: six metadata items and the Components. Other embodiments can be implemented that have different Entry parts, for example, that do not include a Fast Find part.

### Entry Metadata Items

These are secondary data items that support implementation of the Entry in the dbe, as shown in the Entry block in Box 1 of FIG. 2.

### Fast Find

The Entry includes an Entry Name. This Entry Name facilitates implementation of a Graph database with this database engine, and makes Entry referral more convenient in many instances. The Entry Name is optional. The Entry includes a “Fast Find” list of one or more keywords for each Entry in the database file. The keyword facilitates fast searching of the database because these keywords are representative of the content of the respective Entry; that is, they summarize the content of their respective Entry. In an example, “Fast Find” is implemented as a variable-length text string consisting of a list of space-delimited (in first version) words placed at the top of the respective Entry structure, replacing the Entry Size as the first (top) item in the top structure of the Entry; hence, this is the very first item to be read in the Entry structure. As such, with an effective selection of keywords, “Fast Find” results in faster searches than searching each entire Entry because “Fast Find” is placed as the first item in the top structure of the respective Entry. This is advantageous because searching does not require time-consuming reading (searching) of the entire contents of each Entry and time-consuming “unpacking” deserialization of each Entry from the disk (volume) file. Instead, the database engine can just read the “Fast Find” at the top of each Entry. This may even significantly reduce the need for indexing. This can be implemented, or not implemented, in various versions of the database engine, because the DVIS will flag the database engine of the presence of the “Fast Find” so that the database engine can adjust its operation accordingly. In some implementations, “Fast Find” is implemented as a variable-length string; specifically, in C++ it will be initially implemented as:
unsigned short fast_find_text_length; // (Used with the text pointer below.)
char*fast_find_text_pointer;
   In C# “Fast Find” is implemented as simply a string in the Entry class; specifically,
public string FastFind {get; set;}=“”;

### Entry Size

The Entry includes an “Entry size” e.g., in bytes. The Entry size is generated by the dbe based on the size of the Entry. This may be used by the dbe for file i/o, and it can be displayed for user convenience. Generally, the entry size cannot be directly modified by the user, although the user can indirectly change the entry size by, for example, adding another component to the Entry, revising a Component of an Entry, or deleting a Component of an Entry, in which case the dbe calculates another corresponding Entry size.

### Entry Number

The dbe assigns an Entry Number to each Entry. In some embodiments, the dbe assigns chronological integers for the Entry Numbers, but other numbering schemes may be used for this. This is used by the dbe to reference Entries for various operations as described elsewhere in this document. The entry number is controlled by the dbe and cannot be modified by the user.

### Status

The status is a character that can be either ‘a’ for “active” or ‘d’ for deleted. When an Entry is deleted, this data is set as for that Entry; else, this is set as ‘a.’ The function of this character is described elsewhere in this document. The status cannot be modified by the user.

### Number of Components

This gives the number of Components contained in the Entry. This is used to facilitate file i/o, and it can be displayed for user convenience.

### Components

The Entry also includes the Components of, or associated with, the Entry. Components are the main part of the Entry. Components hold the data entered by the client (user). The Components are the “building blocks” of the Entry, and they are detailed in a following section below.

### Components Structure

Data (e.g., client data) is stored in an Entry in the form of one or more Components. There are four types of Components corresponding to four different types of data: text, numeric, date, and a special fourth type of Component called Connection Component of which there are four types: Explosion, Implosion, Flat, and Custom, as illustrated in Box 3 of FIG. 2. When data is received by the dbe to be stored in the database, each item of client data that is to be stored in an Entry is first classified as one of the four main types of data Components (e.g., numeric, text, date, or connection), and then stored in the Entry in the respective type of Component.

Components are the “building blocks” of an Entry, and the Component is the most elementary unit of data in this database. The four types of Components (e.g., numeric, text, date, and connection) are described below and illustrated in FIG. 2.

### Text Component

The text Component includes the text Component name (Box 2) and the text content of the Component (Box 5). For example, a text Component listing the type of customer as “retail” may have a Component name of “Customer Type” and text content of “retail.” A typical display of this text Component in the database is, Customer Type: retail. As can be seen in FIG. 2, the text Component also includes the length of the text content (Box 5) as an item of metadata to facilitate implementation in the dbe.

### Numeric Component

The numeric Component consists of the numeric Component name (Box 2), numeric value (Box 4), and units (Box 4). The units are optional. For example, a numeric Component listing height as 6.1 feet may have a Component name of “height”, numeric value of 6.1, and units of “feet.” A typical display of this numeric Component in the database is, height: 6.1 (feet). The numeric type may have several options; for example, integer, float, or decimal.

### Date Component

The date Component consists of the date Component name (Box 2) and the date (Box 6). The current version of this database stores the date internally as a Unix timestamp value, as shown in FIG. 2. For example, a date Component listing the date of the first interaction with a customer (or client) as May 15, 2019 may have a Component name of “First Interaction Date” and a date value of 5/15/2019. A typical display of this date Component in the database is, First Interaction Date: 5/15/2019.

### Explosion Component

The Explosion Component is a special data type in this database that consists of the Entry number of an Entry that has a subordinate hierarchical relationship to the Entry that contains this Explosion Component (this Entry) and a Reference Designator. This Entry number is called the Connection Entry Number (Box 7). The Reference Designator (Box 7) is a name or label representing the hierarchical relationship between this Entry and the corresponding subordinate Entry. The Reference Designator is optional. Unlike other Components, an Explosion Component does not have a Component name. (The dbe automatically populates the Component name for an Explosion Component with a placeholder value not visible to or accessible by the client.) However, in another embodiment of this dbe, the Component name may be used instead of the reference designator, and the reference designator may be eliminated.

For example, if an Entry represents an assembly, and this assembly contains a screw (hardware) that has an Entry number of 1897 and is identified in an assembly diagram with the label S19, then an Explosion Component may be added to this Entry with an Explosion Entry Number of 1897 and a Reference Designator of S19, with this Reference Designator representing the subordinate hierarchical relationship between the assembly (this Entry) and the screw (a Subordinate Entry). A typical display of this Explosion Component in the database would be: Reference Designator: S19 Entry Number: 1897 . . . <details of Entry #1897 would be printed here>.

Another example of an Explosion Component would be if an Entry represents a customer (or client), and this customer sent in a suggestion that we recorded as an Entry in this database with Entry #19246, then an Explosion Component may be added to this customer Entry representing the suggestion, with the Explosion Entry Number set equal to the Entry number of the suggestion, 19246, and the Reference Designator set as “Suggestion.” A typical display of this Explosion Component in the database would be, Reference Designator: Suggestion Entry Number: 19246 . . . <details of Entry #19246 would be printed here>. In various embodiments, implementations of this example can also be done with a Custom-Connection Component, described elsewhere in this document.

To facilitate faster information retrieval during an Explosion query, the Explode Component contains the name of the Entry to which the Explode Component points to so that an Explode query outputting the Connected Entry Name can be performed quickly without needing to retrieve the Connected Entry Name from the Connected Entry during the Explode query. (Reciprocal Component Name and Reciprocal Reference Designator are also contained, but not used for the Explode Component because the Explode Components have no Component Name and both the Explode Component and its corresponding Explode Reciprocal Connection Component have the same Reference Designator (if any)).

The database engine automatically creates the corresponding Implode Reciprocal Connection Component in the respective Connected Entry right after the Explode Component is created.

### Implosion Component

The Implosion Component is the opposite of the Explosion Component. The Implosion Component is a special data type (connection data) in this database that consists of the Entry number of an Entry that has a superordinate hierarchical connection to the Entry that contains this Implosion Component (this Entry) and a Reference Designator. The Entry number of the Entry that has the superordinate connection (Implosion Entry Number) is stored as the connection Entry Number (Box 7 FIG. 2). The Reference Designator (also Box 7) is a name or label representing the hierarchical connection between this Entry and the corresponding superordinate Entry. The Reference Designator is optional. Unlike other (non-connection) Components, an Implosion Component does not have a Component name. (The dbe automatically populates the Component name for an Implosion Component with a placeholder value not visible to or accessible by the client.) However, in another embodiment of this dbe, the Component name may be used instead of the reference designator, and the reference designator may be eliminated.

To facilitate faster information retrieval during an Implosion query, the Implode Component contains the name of the Entry to which the Implode Component points to so that an Implode query outputting the Connected Entry Name can be performed quickly without needing to retrieve the Connected Entry Name from the Connected Entry during the query. (Reciprocal Component Name and Reciprocal Reference Designator are also contained, but not used for the Implode Component because the Implode Components have no Component Name and both the Implode Component and its corresponding Implode Reciprocal Connection Component have the same Reference Designator (if any)).

The database engine automatically creates the corresponding Explode Reciprocal Connection Component in the respective Connected Entry right after the Implode Component is created.

### Flat Component

The Flat Component is a special data type (connection data) in this database that consists of the Entry number of an Entry that has a “flat” (non-hierarchical) connection to the Entry that contains this Flat Component (this Entry) and a Reference Designator. The Entry number of the Entry that has the “flat” connection (Flat-Connection Entry Number) is stored as the connection Entry Number (Box 7 FIG. 2). The Reference Designator (also Box 7) is a name or label representing the “flat” connection between this Entry and the corresponding “flat”-connected (non-hierarchical connection) Entry. The Reference Designator is optional. Unlike other (non-connection) Components, a Flat Component does not have a Component name. (The dbe automatically populates the Component name for a Flat Component with a placeholder value not visible to or accessible by the client, similar to Explosion and Implosion Components.) However, in another embodiment of this dbe, the Component name may be used instead of the reference designator, and the reference designator may be eliminated.

To facilitate faster information retrieval during a Flat-Track query, the Flat-Track Component contains the name of the Entry to which the Flat-Track Component points to so that a Flat-Track query outputting the Connected Entry Name can be performed quickly without needing to retrieve the Connected Entry Name from the Connected Entry during the query. (Reciprocal Component Name and Reciprocal Reference Designator are also contained, but not used for the Flat-Track Component because the Flat-Track Components have no Component Name and both the Flat-Track Component and its corresponding Flat-Track Reciprocal Connection Component have the same Reference Designator (if any)).

The database engine automatically creates the corresponding Flat-Track Reciprocal Connection Component in the respective Connected Entry right after the Flat-Track Component is created here in the Origin Entry.

### Custom-Connection Component

The Custom-Connection (Custom-Track) Component is a special data type (connection data) in this database that consists of the Entry number of an Entry that has a custom, user-defined connection to the Entry that contains this Custom-Connection Component (this Entry) and a Reference Designator. The Entry number of the Entry to which the custom, user-defined connection is made (the Custom-Connection Entry Number) is stored as the connection Entry Number (Box 7 FIG. 2). The Reference Designator (also Box 7) is a name or label representing the custom connection between this Entry and the corresponding user-defined, custom connection Entry. The Reference Designator is optional. The name of this custom, user-defined connection is placed as the Component Name (Box 2 FIG. 2).

To facilitate faster information retrieval during a Custom-Track Connection query, the Custom-Track Connection Component also contains 3 other elements: Connection Entry Name, Reciprocal Component Name, and Reciprocal Reference Designator. The Connection Entry Name contains the Entry Name of the Connected Entry (if any). The Reciprocal Component Name and Reciprocal Reference Designator contain the Custom Connection Name (Component Name) and Custom Connection Reference Designator (if any), respectively, of the corresponding Custom-Track Reciprocal Connection Component (in the Connected Entry) if the user chose to create the Reciprocal Connection. The user is given the option to create a corresponding Custom-Track Reciprocal Connection Component when creating the Custom-Connection Component. To summarize, the Connection Entry Name=Entry Name of the Connected Entry, Reciprocal Component Name=Component Name (Custom Connection Name) of the Connected Entry, and Reciprocal Reference Designator=Reference Designator of the Connected Entry. The database engine could go to the Connected Entry to find these items instead of storing them in the Custom-Track Connection Component; however, inclusion of this data can save considerable time when outputting the Custom Connections of an Entry. It can be thought of as a kind of indexing scheme.

Simple Example: if Entry Number 1822 represents a customer named Bob, and if Entry Number 2317 represents an orange juice product called “Super Orange Juice” that Bob likes, then a Custom-Connection Component can be created in Entry 1822 with Custom-Connection Entry Number 2317 and custom connection name set to the word “likes.” Then, this Custom-Connection Component in the Entry for Bob (Entry #1822) effectively connects Bob to the Super Orange Juice product (Entry #2317) with a connection named “likes”; hence, this connection effectively states that Bob (Entry #1822) “likes” Super Orange Juice (Entry #2317). Also, this is a simple example of implementing a Graph database with this database engine. The Entry data structure (data class) contains an Entry Name for each Entry to facilitate Graph Database implementation with this database engine.

Hence, it can be seen that this native Custom-Connection capability can be used to implement a Graph Database. It should be noted, however, that a Graph Database can also be implemented with Flat Components or, in a hierarchical manner, with Explosion or Implosion Components with the Reference Designator used to name the connection. Moreover, an embodiment of this invention may eliminate the Custom-Connection Component by substituting the hierarchical (Explosion and Implosion) Components or the Flat-Connection Component to implement a Graph Database (custom connection). Also, an embodiment of this invention may eliminate the reference designator, using the Component Name in lieu of the reference designator.

### Universe

Every Entry in this database is placed in a single area called the “Universe” (unlike other commonly-used databases with data placed in complex combinations of multiple Tables, Collections, etc.). See FIG. 1.

In addition to containing every Entry, the Universe also contains the Next Entry Number, such that when a new Entry is added to this database, the Next Entry Number is read from the Universe and assigned as the Entry Number of the new Entry. The Next Entry Number in the Universe is then updated and stored in the Universe, waiting for the next New Entry. Note that in the first version of this database, the Entry Number is an integer that is simply incremented as new Entries are added; however, this simple increment approach is not endemic to this database engine, and another Entry numbering scheme could be used.

The Universe contains everything (every entity) in the database; hence, the Universe is coincident with the database file. The database file (as used herein) may be on a single physical device (single computer drive) or span multiple physical devices, such as a RAID drive system or server sharding. As mentioned above, some embodiments, the Universe also contains a string called a Database Version Information String (DVIS) that is used by the database engine to determine the specific version of the database file, so that it can be run correctly by the database engine. This can be advantageous because newer, various, or custom versions of the database engine may require changes to the database file structure, for example, to improve performance, lower cost, increase reliability, for new features, etc. In such implementations, when the database engine first reads a database file, it must first read this DVIS to determine specifically which version of database file it is working with in order to “know” how to correctly use (read, write, and modify) the database file.

The database engine can have the capability to work in multiple Universes simultaneously. It may also provide an interface capability between Universes.

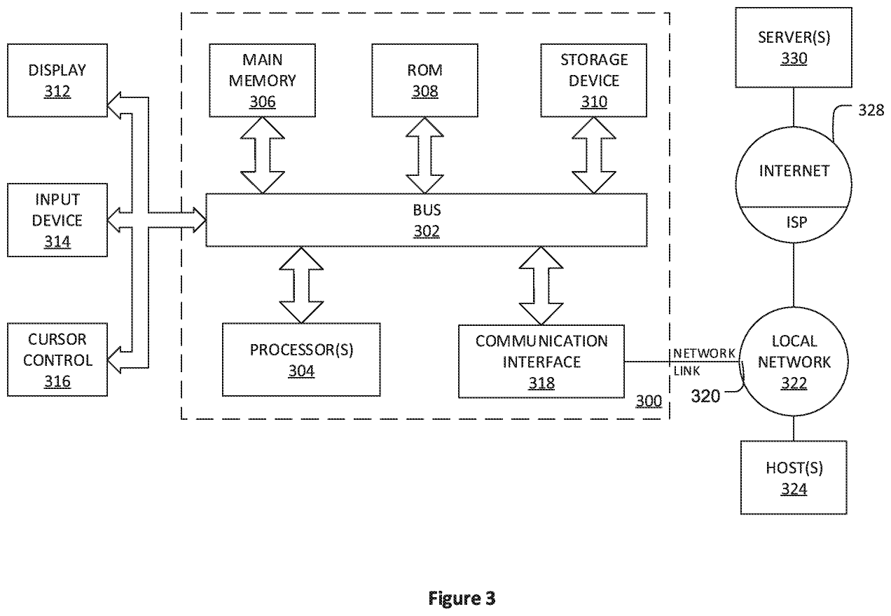

FIG. 3 illustrates an example of one embodiment of a computer system 300 with which certain technology and methods described herein may be implemented, according to some embodiments. For example, one or more processors of the computer system 300 can be used to execute the processor-executable instructions to implement the embodiments of a database engine described herein to perform a transaction to save data to, retrieve data from, or modify at least data portion in a database. The database can be, for example, structured to include a next entry number indicative of the number that will be assigned to the next entry that is entered into the database, a plurality of entry structures, each entry structure including information of (i) an Entry Name, (ii) a Fast Find keyword list, (iii) an entry size, (iv) an entry number, (v) a status, and (vi) a total number of components associated with the entry, each entry having one or more components associated with the entry, and (vii) the components associated with the entry; and a plurality of component structures, each component structure including information of (i) a component name, (ii) a component type, and (iii) contents of the component, each component being associated with only one entry, and each component being of one of a numeric data type structure, a text data type, a date data type, or a connection data type, such that each component has only one type of data type. In some embodiments, additional or other data type may be used. For example, a data type can be defined to binary data (e.g., a binary data file) that is suitable for storing an image. The flexible design of the data structure illustrated in FIG. 2 as described herein facilitate adding new data types if/when they are needed.

Still referring to the example illustrated in FIG. 3, the computer system 300 includes a bus 302 or other communication mechanism for communicating information, and a hardware processor, or multiple processors, 304 coupled with bus 302 for processing information. Hardware processor(s) 304 may be, for example, one or more general purpose microprocessors.

Computer system 300 also includes a main memory 306, such as a random access memory (RAM), cache and/or other dynamic storage devices, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions. The main memory 306 may, for example, include instructions for a database engine to perform a transaction to save data to, retrieve data from, or modify at least a portion of the data in a database.

Computer system 300 further includes a read only memory (ROM) 308 or other static storage device coupled to bus 302 for storing static information and instructions for processor 304. A storage device 310, such as a magnetic disk, optical disk, or USB thumb drive (Flash drive), SSD, etc., is provided and coupled to bus 302 for storing information and instructions.

Computer system 300 may be coupled via bus 302 to a display 312, such as a cathode ray tube (CRT) or LCD display (or touch screen), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor. Input 314 can also include a game pad or virtual reality input devices.

Computing system 300 may include a user interface module to implement a GUI that may be stored in a mass storage device as computer executable program instructions that are executed by the computing device(s). Computer system 300 may further, implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor(s) 304 executing one or more sequences of one or more computer readable program instructions contained in main memory 306. Such instructions may be read into main memory 306 from another storage medium, such as storage device 310. Execution of the sequences of instructions contained in main memory 306 causes processor(s) 304 to perform the process steps described herein. In alternative embodiments, hard-wired circuitry may be used in place of or in combination with software instructions.

Various forms of computer readable storage media may be involved in carrying one or more sequences of one or more computer readable program instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN (or WAN component to communicate with a WAN). Wireless links may also be implemented such as Bluetooth. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 328. ISP 328 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

Accordingly, in some embodiments of the computer system 300 in FIG. 3, the computer system comprises a first non-transitory computer storage medium storage device 310 configured to implement a database engine to perform a transaction to save data to, retrieve data from, or modify at least a portion of the data in a database structured as described in FIG. 2 herein. The computer system 300 can further comprise a second non-transitory computer storage medium main memory 306 configured to at least store computer-executable instructions. The computer system can further comprise one or more computer hardware processors 304 in communication with the second non-transitory computer storage medium main memory 306, the one or more computer hardware processors 304 configured to execute the computer-executable instructions to at least configure the one or more computer memory components to store information in a database, the database including a next entry number indicative of the entry number that will be assigned to the next entry that is entered into the database as shown in FIGS. 1B and 4A, and a plurality of entries, each entry structure as shown in FIG. 2 including information including a Fast Find keyword list, an entry size, an entry number, a status of the entry, the total number of components in the respective entry, each entry having one or more components, and the components of the entry, where each of the components can include a component name, a component type, and data content of the component, where each component is contained in only one entry, and each component being of one of a numeric data type, a text data type, a date data type, or a connection data type, such that each component has only one type of data type. The one or more computer hardware processors 304 as shown in FIG. 3 are further configured to execute the computer-executable instructions to at least perform a transaction to add, retrieve and/or change or delete information stored in the Entries in the database.

The computer system 300 can include many other aspects. In an embodiment, the one or more computer hardware processors 304 of the computer system 300 are further configured to execute the computer-executable instructions to operate a database engine to store a first entry of the plurality of entries, the first entry including a first entry number and an explosion-type connection component; and store a second entry of the plurality of entries, second entry including a second entry number and an implosion-type connection component, wherein the second entry implosion-type connection component includes the first entry number indicating the first entry has a superordinate hierarchical relationship relative to the second entry, and wherein the first entry explosion-type connection component includes the second entry number indicating the second entry has a subordinate hierarchical relationship relative to the first entry. In another example, the one or more computer hardware processors 304 of the computer system 300 are further configured to execute the computer-executable instructions to operate a database engine to store a first entry of the plurality of entries, the first entry including a first entry number and a flat-type connection component, and store a second entry of the plurality of entries, second entry including a second entry number and a flat-type connection component, wherein the second entry flat-type connection component includes the first entry number indicating the second entry has a non-hierarchical relationship to the first entry, and wherein the first entry flat-type connection component includes the second entry number indicating the first entry has non-hierarchical connection to the second entry.

In another example, the one or more computer hardware processors 304 of the computer system 300 are further configured to execute the computer-executable instructions to operate a database engine to store a first entry of the plurality of entries, the first entry including a first entry number and an flat-type connection component, and store a second entry of the plurality of entries, second entry including a second entry number and a flat-type connection component, wherein the second entry flat-type connection component includes the first entry number indicating the second entry has a non-hierarchical relationship to the first entry, and wherein the first entry flat-type connection component includes the second entry number indicating the first entry has non-hierarchical connection to the second entry. In another example, the one or more computer hardware processors 304 of the computer system 300 are further configured to execute the computer-executable instructions to operate a database engine to store a first entry of the plurality of entries, the first entry including a first entry number and a custom-type connection component, wherein the custom-type connection component including an entry number of a second entry indicating that the first entry has a connection to the second entry, the custom-type connection component further comprising a reference designator representative of the connection between the first entry and the second entry.

This database invention may be used in a wide range of computing environments, including on a PC, server, cloud, or for large or light-weight embedded applications.

Code sample for the Entry Class and the Numeric Data Component subclass of the Components Abstract Class. The Entry Class is a subclass of the Universe Class.

```
  class Entry : Universe
  {
  public string EntryName { get; set; } = “”;
  public string FastFind { get; set; } = “”;
  public long EntrySize { get; set; } = 0;
  public long EntryNumber { get; set; } = 0;
  public char Status { get; set; } = ‘a’;
  public int NumberOfComponents { get; set; } = 0;
  public List<Components> theComponents =
  new List<Components>( );
  public Entry( )
  {
}
}
    abstract class Components
    {
  public string ComponentName { get; set; } = “”;
  public char ComponentType { get; set; } = ‘z’;
  }
  class NumericData : Components
  {
    public decimal NumericValue { get; set; } = 0.0M;
    public string Units { get; set; } = “”;
  public NumericData(string componentName,
  decimal numericValue, string units)
    {
      ComponentName = componentName ;
      ComponentType = ‘n’;
      NumericValue = numericValue;
      Units = units;
    }
}
```

FIG. 4A illustrates an example of a Database File Architecture, according to some embodiments. Since the “Universe” is coincident with the database file, the Universe description above applies to the database file. Specifically, the database file includes three items: the Database Version Information String as the first item in the file, (at the “top” of the file), the next Entry number followed by the set of every Entry, as the third item in the file. See FIG. 4A.

When a new Entry is added to the database, the “Next Entry Number” is read from the top of the database file, and it is assigned to the new Entry. This value is then incremented (or in another manner to create the Entry number for the next new Entry) and stored at the top of the database file, to be assigned as the Entry number of the next new Entry that is added to the database. In some embodiments, integer Entry numbers are incremented as Entries are added. However, in general, another Entry numbering scheme could be used in other embodiments.

### Database Engine Operations

The metadata in Box 1 FIG. 2 (Entry Name, Fast Find, Entry Size, Entry Number, Status, and Number of Components) is automatically generated and entered into an Entry structure by the database engine.

### Component User Data

The Component data is received from user input in Box 2 FIG. 2 and one of Boxes 4-7 in FIG. 2 depending on the type of Component (except for Component Name in Box 2 for Explosion, Implosion, and Flat Connection Components, which is populated with a special, internal value by the database engine in those cases, and text data length in Box 5, which is computed by the database engine. Text data length is optional depending on implementation; for example, is C# .NET implementation, the “length of text content” is unnecessary. In another embodiment, the Component Name may be used instead of the reference designator, with the reference designator omitted).

### Setting Up Text, Numeric, and Date Components

The specific data entry for each of these types of Components is self-explanatory, and follows the prior Database Engine Data Structure section and FIG. 2.

### Setting Up Explosion, Implosion, and Flat-Track Connection Components.

To implement these Components, two separate, simultaneous Components must be created: the Component itself, and its complementary Component (Reciprocal Connection Component) at the connected Entry.

To implement an Explosion Component, both the Explosion Component itself and a corresponding Implosion Component described below are both completed (e.g., simultaneously) automatically by the database engine.

### Set Up Explosion Component

### Explosion Component

Implement the Explosion Component (Box 7, FIG. 2) with the Explosion Entry Number as the connection Entry Number, and the reference designator (if any). The database engine automatically checks that the Connection Entry exists before creating the Explosion Connection Component. Also, the database engine automatically populates the Connection Entry Name with the Name of the Entry (if any) pointed to by the Explosion Component. This is done for faster Explode queries so that the database engine does not have to seek to the Connected Entry to find the name of the Connected Entry to include in the Explode query. Reciprocal Component Name and Reciprocal Reference Designator are present but not used for the Explosion Component (they are used for Connection Components).

### Corresponding Implosion Component

Simultaneously, the database engine automatically adds a corresponding Implosion Component (Box 7, FIG. 2) at the Entry with Entry Number=Explosion Entry Number, and sets the Implosion Entry Number equal to the Entry Number of the Entry that contains the above corresponding Explosion Entry as the connection Entry Number (Box 7, FIG. 2), and the reference designator (if any).

### Set Up Implosion Component

To implement an Implosion Component, both the Implosion Component itself and a corresponding Explosion Component per below are completed simultaneously automatically by the database engine. The Implosion Component can be thought of as the “dual” of the Explosion Component. The Implosion Component is the corresponding Reciprocal Connection Component of the Explosion Component.

### Implosion Component

Implement the Implosion Component (Box 7, FIG. 2) with the Implosion Entry Number as the connection Entry Number, and the reference designator (if any). The database engine automatically checks that the Connection Entry exists before creating the Implosion Connection Component. Also, the database engine automatically populates the Connection Entry Name with the Name of the Entry (if any) pointed to by the Implosion Component. This is done for faster Implode queries so that the database engine does not have to seek to the Connected Entry to find the name of the Connected Entry to include in the Implode query. Reciprocal Component Name and Reciprocal Reference Designator are present but not used for the Implosion Component (they are used for Connection Components).

### Corresponding Explosion Component

Simultaneously, the database engine automatically adds a corresponding Explosion Component (Box 7, FIG. 2) at the Entry with Entry Number=Implosion Entry Number, and sets the Explosion Entry Number equal to the Entry Number of the Entry that contains the above corresponding Implosion Entry as the connection Entry Number (Box 7, FIG. 2), and the reference designator (if any).

### Set Up Flat-Track Component

To implement a Flat Component, both the Flat Component itself and a corresponding, complementary Flat Component per below must be completed simultaneously. This is done automatically by the database engine.

### Flat Component

Implement the Flat Component (Box 7, FIG. 2) with the Flat-Connection Entry Number as the connection Entry Number, and the reference designator (if any). The database engine automatically checks that the Connection Entry exists before creating the Flat-Track Connection Component. Also, the database engine automatically populates the Connection Entry Name with the Name of the Entry (if any) pointed to by the Flat-Track Connection Component. This is done for faster Flat-Track queries so that the database engine does not have to seek to the Connected Entry to find the name of the Connected Entry to include in the Flat-Track query. Reciprocal Component Name and Reciprocal Reference Designator are present but not used for the Flat-Track Component (they are used for Connection Components).

### Corresponding, Complementary Flat-Track Component

Simultaneously, the database engine automatically adds a corresponding, complementary Flat Component (Box 7, FIG. 2) at the Entry with Entry Number=Flat-Connection Entry Number (from the above step), and sets the Flat Entry Number of this complementary Flat Entry equal to the Entry Number of the Entry that contains the above corresponding Flat Entry as the connection Entry Number (Box 7, FIG. 2), and the reference designator (if any).

### Setting Up Custom-Track (User-Defined) Components

This Custom-Connection Component type is named by the user, and the Custom-Connection name is stored as the Component Name (Box 2, FIG. 2). The Custom-Connection Component may, optionally, have a corresponding, complementary Component. Unlike the Explosion, Implosion, and Flat Components, a corresponding, complementary component is optional, and is not automatically populated by the database engine; instead, the database engine gives the user an option to create the corresponding, Custom-Track Reciprocal Connection Component right after the creation of the Custom-Track Component.

### Custom-Track Connection Component

Implement the Custom-Track Connection Component (Box 7, FIG. 2) with the connection Entry Number set equal to the Entry Number of the Entry to which this entry will connect (Custom-Track Connection Entry Number). Also, include the reference designator (if any). The database engine automatically checks that the Connection Entry exists before creating the Custom-Track Connection Component. Also, the database engine automatically populates the Connection Entry Name with the Entry Name of the Connected Entry (if any), and automatically populates the Reciprocal Component Name and Reciprocal Reference Designator with the Custom Connection Name (Component Name) and Custom Connection Reference Designator (if any), respectively, of the corresponding Custom-Track Reciprocal Connection Component (in the Connected Entry) if the user chose to create the Reciprocal Connection. The user is given the option to create a corresponding Custom-Track Reciprocal Connection Component when creating the Custom-Connection Component. The database engine could seek to the Connected Entry to find these items during a Custom-Track Connection query instead of storing them in the Custom-Track Connection Component, but including this data in the Custom-Track Connection Component can save considerable time when outputting the Custom-Track Connections of an Entry during a Custom-Track Connection query, saving time like an indexing arrangement.

### Optional, Complementary Custom-Track Connection Component

If the user chooses to create a corresponding Custom-Track Reciprocal Connection Component, then the database engine automatically implements the respective Custom-Track Reciprocal Connection Component in the Connected Entry automatically setting the Connection Entry Number (Box 7, FIG. 2) to the Entry Number of the above Custom-Track Connection Component, setting the Reciprocal Component Name to the Component Name of the above Custom-Track Connection Component, setting the Reciprocal Reference Designator to the value of the Reference Designator (if any) of the above Custom-Track Connection Component, and setting the Connection Entry Name to the Entry Name of the Entry containing the above Custom-Track Connection Component. The user enters the Connection Name of this Custom-Track Reciprocal Connection Component, which the database engine stores as its Component Name, and the user also enters the Reference Designator, if any. As noted prior, the Connection Entry Name, Reciprocal Component Name, and Reciprocal Reference Designator are included to save Custom-Track Connection query time.

### Explode, Implode, Flat-Track, and Custom-Track Connection Query Operations

This section details the four Connection (relationship) query operations. These operations are all straight-forward using their respective Connection (relation) Components.

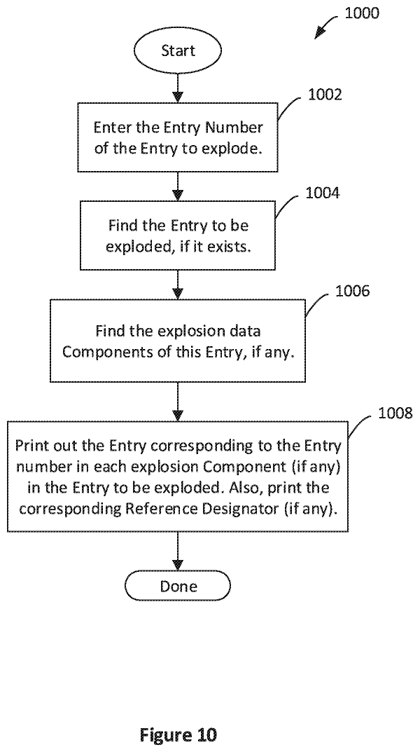

Explosion Operation: Explode-Connection query operation is detailed as per FIG. 10. A faster version of this can be implemented to just print out the Connection Entry Number, Reference Designator, and Connection Entry Name (if any) without printing out the actual Entry. This can save significant time because it eliminates the seek Entry operation.

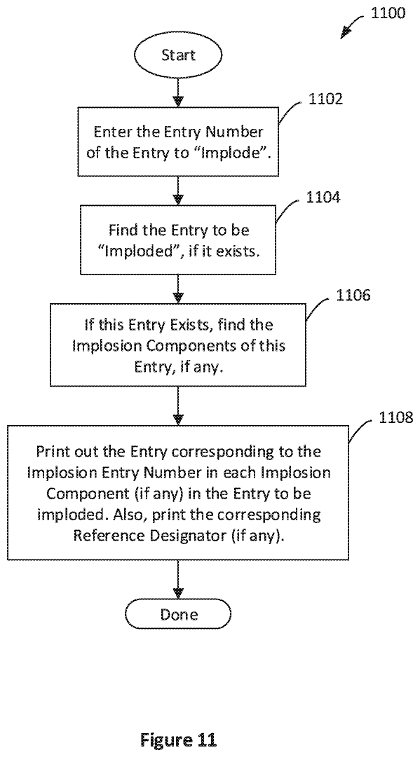

Implosion Operation: This Implode-Connection query operation is detailed as per FIG. 11. A faster version of this can be implemented to just print out the Connection Entry Number, Reference Designator, and Connection Entry Name (if any) without printing out the actual Entry. This can save significant time because it eliminates the seek Entry operation.

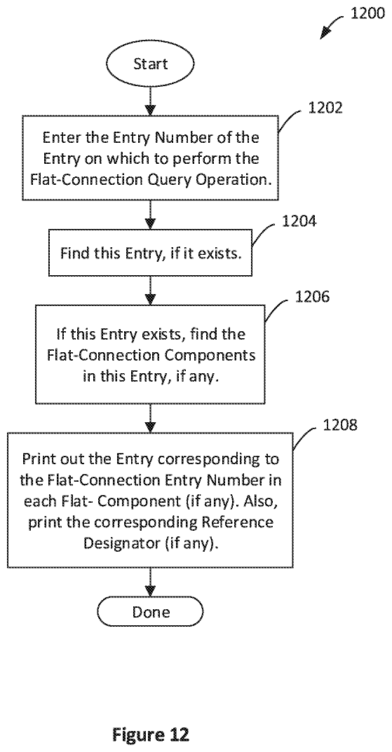

Flat-Track Connection Query Operation: This operation is detailed as per FIG. 12. A faster version of this can be implemented to just print out the Connection Entry Number, Reference Designator, and Connection Entry Name (if any) without printing out the actual Entry. This can save significant time because it eliminates the seek Entry operation.

### Custom-Connection Query Operation

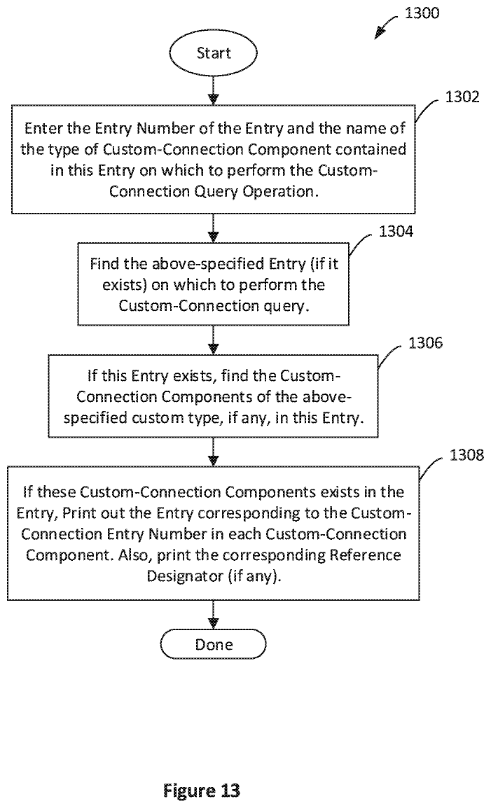

This operation is illustrated in FIG. 13 and described above.

FIG. 4B illustrates an example of a plurality of Entry structures 402, 404, 406 in a Universe 400, according to some embodiments. In various embodiments the number of Entry Structures may be dozens, hundreds, thousands, tens of thousands, hundreds of thousands, millions, billions, or more, as indicated by the ellipses. Each of the Entry structures 402, 444, 406 is a logical structure that can reside on a non-transitory computer memory component, in a structured in accordance with the Entry structure and Component structures described in reference to FIG. 2. As illustrated in FIG. 4B, Entry structure 402 includes an Entry Name, a keyword list (“Fast Find”) entry size, and entry number, a status, the number of components in Entry structure 402, and the Component structures 1-n of Entry structure 402. Each of the one or more Component structures 1-n includes a component name, component type, and the data contents of the respective component. Although in FIG. 4B the plurality of Entry structures 402, 404, 406 may appear to be similarly structured, the illustrated “structure” (e.g., the Entry Name, the Fast Find keyword list, Entry Size, Entry Number, Status, n # of Components, Components 1-n, and for each Component structure the Component Name, Component Type, and Contents) does not represent the actual logical structure of any particular Entry structure, instead it represents what may be included in an Entry structure. Entry structures can be, and often are, structured differently based on the particular data content that they store. That is, because the Entry structure is designed to store a dataset of amorphous data content, although some of the Entry structures may be structured similarly in certain embodiment, in other embodiments the Entry structures storing a data set may have many different structures when used to store, for example, amorphous data.

FIG. 4C illustrates an example of a plurality of Entry structures 420, 430, 440, according to some embodiments. The plurality of Entry structures 420, 430, 440 are similar to the Entry structures 402, 404, 406 except that Entry structures 420, 430, 440 are structured to store particular data content, where the Entry structures 402, 404, 406 represent how the Entry structures may be structured to store data content, that is, what may be include in an entry structure. In other words, the Entry structures 420, 430, 440 have been structured by the dbe to store certain data content. As can be seen in FIG. 4C, as a feature of the flexibility of the defined data storage structure, the actual structure of the Entry structures 420, 430, 440 is significantly different as their structure has been determined based on the actual data content stored in the respective Entry structure. For example, there are no tables (e.g., relational tables) that have columns blank or null information. Entry structures 420, 430, 440 illustrate one example of how the Entry structures 402, 404, 406 in FIG. 4B may be used to store varied amounts, size, and type of data, and that is differently connected.

As illustrated in FIG. 4C, Entry structure 420 (also referred to simply as “Entry 420”) has been structured by the dbe to include a Fast Find keyword list, an Entry structure size:121, an Entry #:1262, status:a, the number of components:1, and the one Component structures having a name:mobile phone, a type:text, and contents:Nelson's business phone. Although Entry structure 420 is illustrated as having only one component, the dbe can add one or more other components to Entry structure 420 without having to redefine any other predefined information about the database or the Entry structure.

Entry structure 430 (also referred to simply as “Entry 430”) has been structured by the dbe to include a Fast Find keyword list, an Entry structure size:421, an Entry #:1272, Status:a, the number of Components:4, and four Component structures: the first Component structure of Entry structure 430 having a Name:screen, a type:text, and contents:screen_type_3; the second Component structure having a Name:battery, a type:text, and contents:batter_type_1; the third Component structure having a name: port, and type:text, and contents:port_type_2; and the fourth Component structure having a name:included in this phone, a type:connection-implosion, an Entry #:1262, and a Reference designator: S4. The fourth component indicates that Entry structure 430 is connect to Entry 420 and has a hierarchical relationship with Entry 420. As defined in FIG. 4C, the relationship between Entry 420 and Entry 430 is that Entry 430 “implodes” into Entry 420. That is in terms of hierarchy, Entry 430 is a child of Entry 420. This hierarchical relationship can also be shown by, for example, including an explosion connection component in Entry 420, the explosion connection component referring to Entry 430. In addition, the screen, the battery, and the port could be separate Entries each imploded to Entry 1262 representing part numbers that make up the phone, with their respective Components providing a list of parameters for each of the parts.

Entry structure 440 (also referred to simply as “Entry 440”) has been structured by the dbe to include a Fast Find keyword list, an Entry structure size:220, an Entry #:1282, Status:a, the number of Components:3, and three Component structures: the first Component structure of Entry structure 440 having a Name:provider, a type:text, and contents:Verizon. The second Component structure having a Name:in service, a type:date, and contents:1573143600. The third Component structure having a name:for phone, and type:connection-flat, and contents:Entry#1262. The third component indicates that Entry structure 440 is connect to Entry 420 and has a hierarchical relationship with Entry 420. As defined in FIG. 4C, the relationship between Entry 420 and Entry 440 is that Entry 440 is on the same hierarchical level as entry 420. That is, in terms of hierarchy, that Entry 440 has a flat connection to Entry 420. In another embodiment, this “flat” hierarchical relationship can be shown by including in both Entry 420 and Entry 440 a component of type connection-implosion, and the database engine can interpret this as indicating a flat relationship between the two entries. Similarly, in another embodiment, this “flat” hierarchical relationship can be shown by including in both Entry 420 and Entry 440 a component of type connection-explosion, in the database engine can interpret this as indicating a flat relationship between the two entries.

Even though the Entries 420, 430, 440 in FIG. 4C have been defined were certain types of information and having certain components, the database engine can be used revise any of these entries such that a component can be added to any entry, the connections between the entries can be changed, and the information included in any component can be changed. In an example, the database engine can add a Component that includes an image to any Entry. In this example, a Component of type text can be added, an image of any size can be included as a text string in the component or a hyperlink to an image. In some embodiments, the Component name may be used by the database engine to indicate that the text represents an image. For example, the Component name may be image_phone33339 to indicate the component is an image of a particular phone (e.g., Nelson's business phone). This is also an example of how an Entry can be used to store a variety of information in a structure that is defined as data is being processed for entry, rather than in a required predetermined or predefined table, schema, object, or other data organization method.

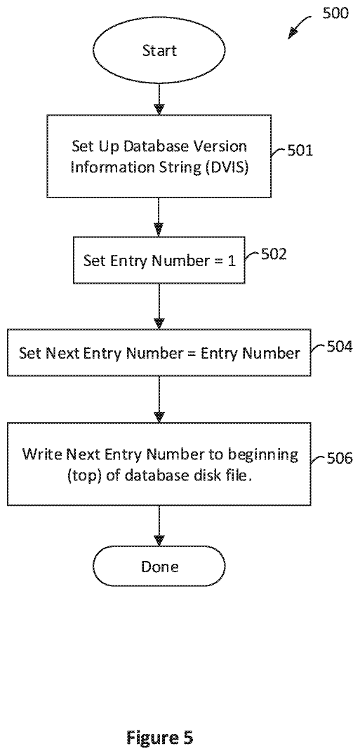

FIG. 5-17 illustrate various examples of flowcharts of methods that can be performed by the database engine described herein, according to some embodiments. In some embodiments, the entry of the information can be performed by user using a user interface displayed on a computer screen and using the data entry device (the keyboard, a mouse, etc.). In other embodiments, the entry of information in the output of information can be facilitated and performed in conjunction with an API that interacts with the database engine to perform the described methods, and other functionality described herein.

### General Database Utility Operations

File Create Operation: To create a new database file, the logic in FIG. 5 is followed.

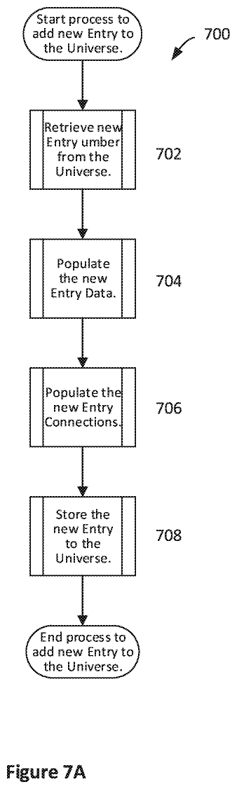

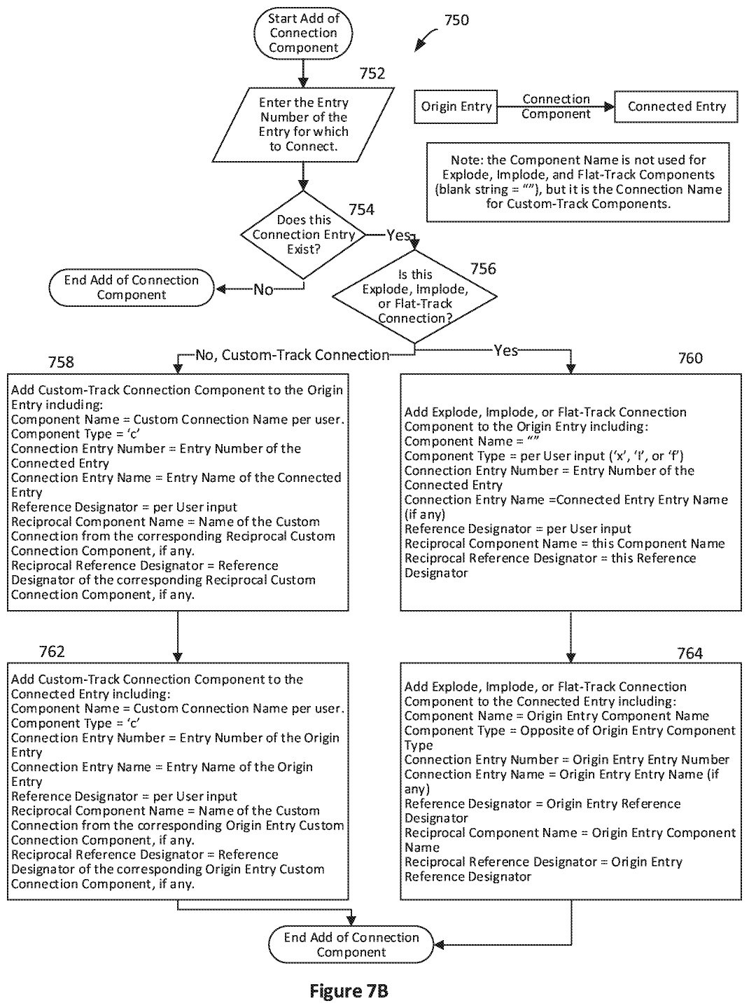

FIG. 5 is a flowchart illustrating an example of a method 500 for creating an Entry—structured file by the dbe, according to some embodiments. The method 500 can be performed by the database engine described herein. The method 500 starts and proceeds to block 501 where it sets up DVIS. Then, the method 500 proceeds to block 502 where it sets an Entry Number equal to 1. In this example, the Entry Number starts at 1, although the Entry Number can start at any number. The method 500 then proceeds to block 504 where it sets the next Entry Number to equal Entry Number. The method 500 then proceeds to block 506 where the next Entry Number is written to the beginning (e.g., near the “top”) of the database disk file (the “Universe”), right under DVIS such that it can be used as the entry number for the next entry when that occurs, subsequently. For example, as illustrated by method 700 in FIG. 7.

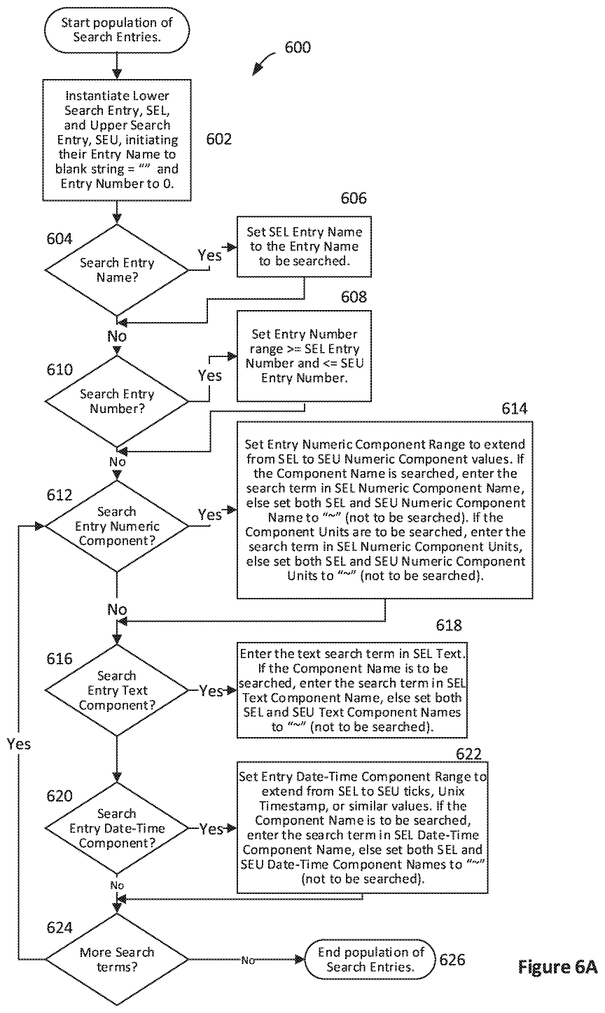

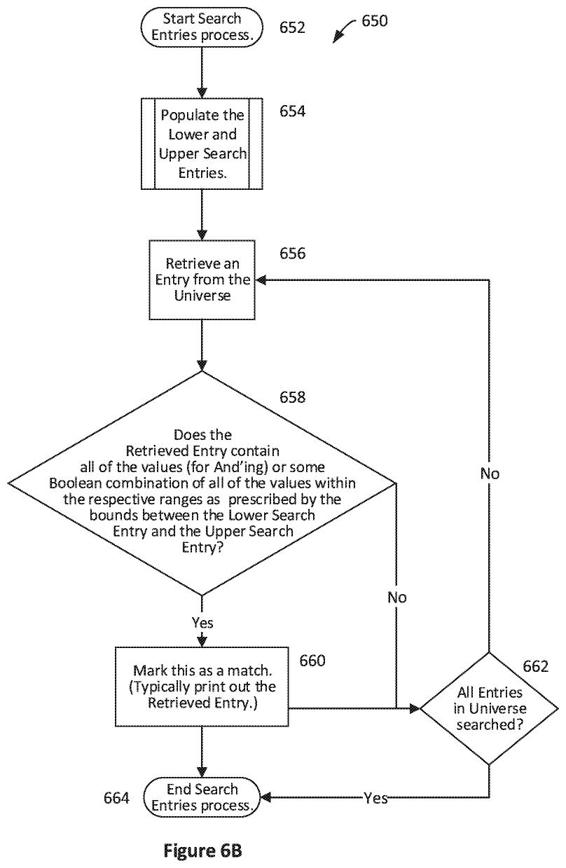

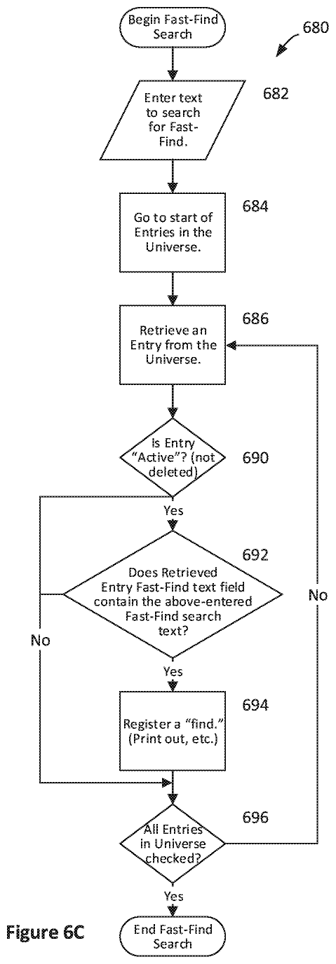

FIGS. 6A and 6B are flowcharts illustrating an example of a method 600 that can be performed by the database engine for searching for information in an Entry, e.g., information that may be stored in a Component of an Entry, according to some embodiments. Specifically, FIG. 6A illustrates a process to populate the lower search and upper Search Entries, which sets up the Search Entries to use as Search Vectors. FIG. 6B illustrates a process for Searching the Universe for Entries with specific values, which is the process called when the user wants to Search the Universe for Entries with specific values. This search uses its own Entry structures as a vehicle to search Entries in the Universe. An Entry must have all values lying within the ranges specified by the Lower Search Entry and the Upper Search Entry for an AND operation (or as per specified by other Boolean combination of Entry value comparisons) to be considered a match. The Upper and Lower Search Entries along with each Retrieved Entry to be searched can be thought of as vectors and this comparison can be thought of as a vector comparison operation. This simplifies complex searches. In some embodiment, Search does not include Connection Components, but in other embodiments it may. Other embodiments are also possible. For example, multiple search terms may be AND'ed together, with a maximum number of search terms (e.g., five). Another version of this database could add an option for search terms to be OR'ed together, and the maximum number of search terms can be readily increased with this database engine. Also, more complex searching can be implemented, including support for regular expressions. FIG. 6C illustrates a process for a Fast-Find Search that allows finding Entries faster by searching only a text field near the top of each Entry. These are further discussed below in reference to FIGS. 6A, 6B, and 6C.

This method uses two Entries as a vehicle to search Entries in the Universe: Search Entry Lower (SEL, the lower search Entry) and Search Entry Upper (SEU, the upper search Entry); specifically, the lower-values of each respective search range are placed in SEL and the upper values of each respective search range are placed in SEU, then the search process goes through each of the Components in the Search Entries comparing the tested (retrieved) Entry to the range limits as defined by SEU and SEL. If the tested Entry satisfies the range limits, that condition is a “find” (a “match”). This method works like a vector comparison, with the set of values in SEL compared to the values in the tested Entry for the lower bound test, and the set of values in SEU compared to the values in the tested Entry for the upper bound test.

In FIG. 6A, method 600 at block 602 initializes Entry Number to 0 and Entry Name to a blank string for both Search Entries, which indicates that Entry Number and Entry Name are initialized not to be searched. Method 600 at block 604 asks whether the Entry Name is to be searched; if yes, method 600 at block 606 sets up as described at block 606. It's a find if searched Entry contains SEL Entry Name. If SEL Entry Name=“”, don't search Entry Names. Method 600 block 610 asks if the Entry Number is to be searched; if yes, method 600 block 608 sets up as described at block 608. It's a find if searched Entry Number lies in this range. Method 600 at block 612 asks if a numeric value is to be searched; if yes, method 600 at block 614 sets up as explained in detail at block 614. It's a find if searched Entry Numeric Component value lies within the range, and SEL Component Name is contained within Searched Entry Component Name, or SEL and SEU Component Names are both=“˜” (not to be searched), and SEL Units are contained within Searched Entry Component Units or both SEL and SEU Units are both=“˜” (not to be searched). Method 600 block 616 asks if a text value is to be searched; if yes, method 600 block 618 sets up as detailed at block 618. It's a find if searched Entry Text Component value contains the SEL text search term, and if the searched Entry Component Name contains the SEL Component Name or both the SEL and SEU Component Names are=“˜” (not to be searched). Method 600 block 620 asks if Date-Time is to be searched; if yes, method 600 block 622 sets up as detailed at block 622. It's a find if searched Entry Date-Time value lies within the range, and SEL Component Name is contained within Searched Entry Component Name, or SEL and SEU Component Names are both =“˜” (not to be searched). Method 600 block 624 asks if more search terms are to be entered; if yes, method 600 block 613 repeats the Component search process, asking if the next search Component is Numeric. If the answer to method 600 block 624 is that there are no more search terms, then the SEU/SEL Search Term population process is done.

FIG. 6A illustrates a process called when the user wants to Search the Universe for Entries with specific values, according to some embodiments. This search uses its own Entry structures as a vehicle to search Entries in the Universe. An Entry must have all values lying within the ranges specified by the Lower Search Entry and the Upper Search Entry for an AND operation (or as per specified by other Boolean combination of Entry value comparisons) to be considered a match. The Upper and Lower Search Entries along with each Retrieved Entry to be searched can be thought of as vectors and this comparison can be thought of as a vector comparison operation. This simplifies complex searches. Search does not include Connection Components at this time, but may in the future. Referring to FIG. 6B, method 650 functions as per the description in the FIG. 6B title block. Method 650 at block 652 starts the Search Entry process. To prepare for searching Entries in the Universe, the SEL and SEU are populated by block 654 in method 650; in particular, not that block 654 was detailed above and in FIG. 6A. Next, method 650 block 656 retrieves an Entry from the Universe, then method 650 block 658 tests the retrieved Entry against the SEL and SEU limits to see if it satisfies the search criteria, and is, therefore, a “find.” Method 650 block 658 then checks the Entry Number to see if it lies within the search range (between the SEL Entry Number and the SEU Entry Number) or SEL Entry Number is 0 for not searching Entry Numbers, and the retrieved entry Entry Name to see if it equals or contains the SEL Entry Name or SEL Entry Name is “” (blank string) to indicate to not search Entry Names. Then, method 650 block 660 marks the retrieved Entry as a match if the respective Boolean criteria have been met; for example, just AND all the tests together if they all must be “true” for an Entry to be a “match”, or some other Boolean combination of the search test results can be used as desired to determine if the Entry is a search “match.” Initial database engine will just AND the test results together so that all test criteria for a given Entry must be true for the Entry to be a search “match.” Next, method 650 block 662 tests to see if any more Entries in the Universe need to be searched; if yes, then method 650 block 656 proceeds to retrieve another Entry from the Universe; else, the search process ends per method 650 block 664.

FIG. 6C is a flowchart showing the Fast-Find process, according to some embodiments. Fast-Find Search. Allows finding Entries faster by searching only a text field near the top of each Entry. Method 680 at block 682 inputs text to search for in the Fast-Find of the Entries in the Universe, and then at block 684 positions to the start of the Entries in the Universe (at the top of the Universe file, right under DVIS and the Next Entry Number location). Method 680 block 686 retrieves an Entry from the Universe and at block 690 checks to see that the Entry is “Active” (not deleted). If the Entry is deleted, block 696 checks if there are more Entries remaining in the Universe to be checked, and if there are more Entries, then the next Entry is retrieved by block 686; else, this Fast-Find search process (method 680) ends. If the Entry is “Active,” block 692 checks if the Fast-Find search text entered in block 682 is contained in the retrieved Entry Fast-Find text field; if so, this is a “find” and the Entry is output (print-out, write to file, or the like). If not, block 696 checks if all Entries in the Universe have been checked and if not, block 686 retrieves another Entry to check; else, this Fast-Find search process (method 680) ends.

FIGS. 7A and 7B are flowcharts illustrating an example of methods 700 and 750 for adding a new entry to a database, according to some embodiments. The database engine can perform methods 700 and 750. Each new Entry may be added to the end of the database file. For example, the nth Entry position as illustrated in FIG. 4A. In some embodiment, the database uses integers for the Entry numbers. However, other numbering schemes or alphanumeric labels can be used in subsequent versions of this database. In some embodiments, the database engine increments the current Entry number to get the next Entry number, however, other numbering schemes can also be used for this database engine.

In FIG. 7A, the process 700 Creates and populates a new Entry, and adds the new Entry to the Universe. Still referring to FIG. 7A, the method 700 starts at block 702 to retrieve a new Entry Number from the Universe; specifically, the next Entry Number is read from the top of the Universe file (FIG. 1B) at the Next Entry Number position. Next, this value is incremented and this incremented value is stored back at the Next Entry Number position at the top of the Universe file. Method 700 block 704 populates the Entry data, including the Entry Name, Entry Number, and the data Components (Numeric, Text, and Date-Time). Next, method 700 at block 706 populates the Entry Connections, including Explode, Implode, Flat-Track, and Custom-Track Connection Components. This is called a “propagated” data add operation because for each Connection Component added to the Entry, the database engine automatically adds the corresponding Reciprocal Connection Component to the corresponding Connected Entry; hence, this process of adding an Entry to the Universe consists of writing this new Entry to the Universe plus writing revised (with Reciprocal Connection Components added) Entries to the Universe for each Connection Component added to this new Entry. Method 700 block 706 is detailed in FIG. 7B as method 750, and will be discussed below. Per method 700 block 708, the new Entry is added to the Universe after data populating is complete. Method 700 is repeated for each new Entry added to the Universe. Referring to FIG. 7B, method 750 details the “propagated” add method used for each Component added to an Entry. To add Connection Components, the respective Connected Entries must be modified to include the corresponding Reciprocal Connection Components. Method 750 block 752 first inputs the Connection Entry Number from the user. The database engine then executes method 750 block 754 to verify that the Connection Entry exists before proceeding. Method 750 block 756 asks if this is an Explode, Implode, or Flat-Track Connection Component, or if this is a Custom-Track Connection Component. If this is a Custom-Track Connection Component, then method 750 block 758 adds the Custom-Track Connection Component to the Entry (Origin Entry), and method 750 block 762 adds the corresponding Custom-Track Reciprocal Connection Component to the Connected Entry. As described elsewhere herein, this Custom-Track Reciprocal Connection Component can be specified by the user or generated automatically by the database engine as an “invisible” Custom-Track Connection Component (so that the database engine “knows” to delete the Custom-Track Connection Component in the Origin Entry if the Connected Entry is deleted, hence preventing an “orphaned” Custom-Track Connection Component. If the Connection Component added is an Explode, Implode, or Flat-Track Connection Component, then method 750 block 760 adds the Connection Component to the Entry (Origin Entry), and method 750 block 764 adds the corresponding Reciprocal Connection Component to the Connected Entry. It can be seen that for each Connection Component added, the respective Connected Entry must be modified with the addition of the corresponding Reciprocal Connection Component, in addition to populating this Entry (Origin Entry). This is the Propagated Add Operation.

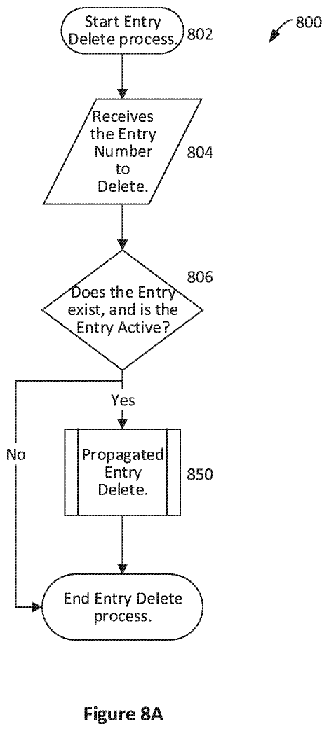

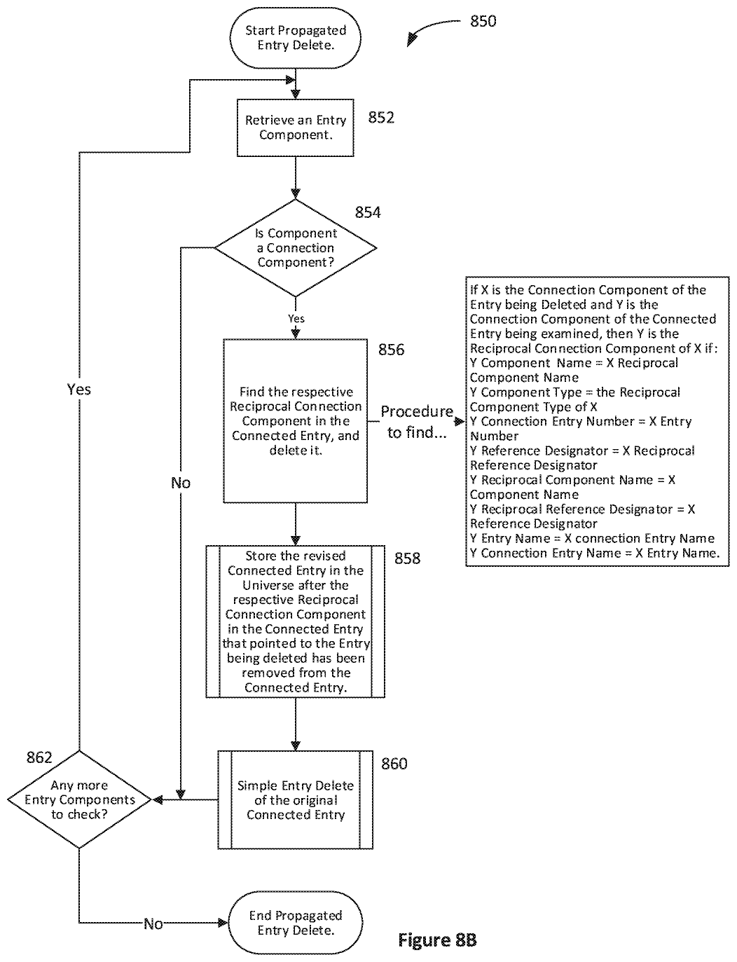

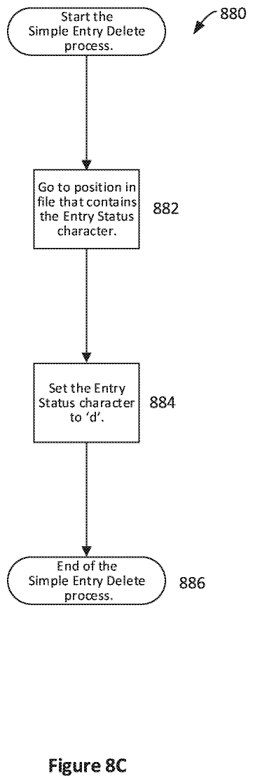

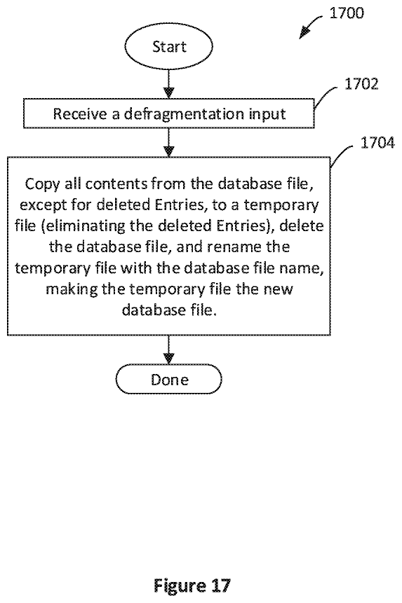

FIGS. 8A, 8B, and 8C are flowcharts illustrating an example of a method 800 for deleting an entry from a database. Referring to FIG. 8A, at block 802 a user can provide an indication to delete an Entry, for example, via a menu on a user interface (or for example, from an API). At block 804, the method 800 receives the Entry number to delete. If the indicated Entry number cannot be found or is marked deleted (status=‘d’) from a prior delete operation, the method 800 block 806 provides feedback that it cannot be found (or is not “Active” in this Universe), and exits the Delete Entry process. If the Entry exists and is Active in this Universe (not status=‘d’ for deleted), then method 800 block 850 executes the Propagated Entry Delete, which not only deletes this Entry, but it also modifies all Connected Entries by deleting the respective Reciprocal Connection Components from all connected Entries, hence the name “Propagated” Delete. This is done automatically by the database engine. This is detailed below in FIG. 8B method 850. After the Propagated Entry Delete, the Entry Delete process is done and exits. In FIG. 8B method 850 implements the Propagated Delete operation. This Propagated Delete Operation which can delete an Entry and all references to the Entry in the respective Connected Entries, and is done for all Connection Components in the Entry being deleted. First, in method 850 at box 852 a Component is retrieved from the Entry. From method 850 box 854 if it is not a Connection Component, go to the next Component or end this process if there are no more Entry Components; else, per method 850 box 856 retrieve the Connected Entry specified by the Connection Entry Number and find the respective Reciprocal Connection Component in the Connected Entry that corresponds to this Connection Component by testing each Component in the Connected Entry per the “Procedure to find” adjacent to box 856 in method 850. When the respective Reciprocal Connection Component in the Connected Entry is found, delete it, and per method 850 box 858 store the revised Connected Entry (with this Reciprocal Connection Component removed). Next, a Simple Entry Delete of this Entry is performed in method 850 box 860. This Simple Entry Delete simply consists of going to the position in the Universe file where the Entry status is and writing the character at this position for mark the Entry as “deleted.” This is detailed in FIG. 8C method 880 which deletes an entry with no regard to Connected Entries. In FIG. 8C, method 880 at box 882 goes to the position in the Universe file containing the Entry Status, and at box 884 simply changes the Entry Status from ‘a’ (for “Active”) to (for Deleted). Finally, method 850 box 862 (FIG. 8B) checks if there are any more Components in the Entry; if yes, then retrieve the next Component per method 850 box 852, else end the process (done). Note, however, that in some embodiments, the Entry is not removed from the database file (e.g., of the drive) until a defragmentation (“Defrag”) operation is executed as described herein. FIG. 17, described below, illustrates an embodiment of a Defrag operation.

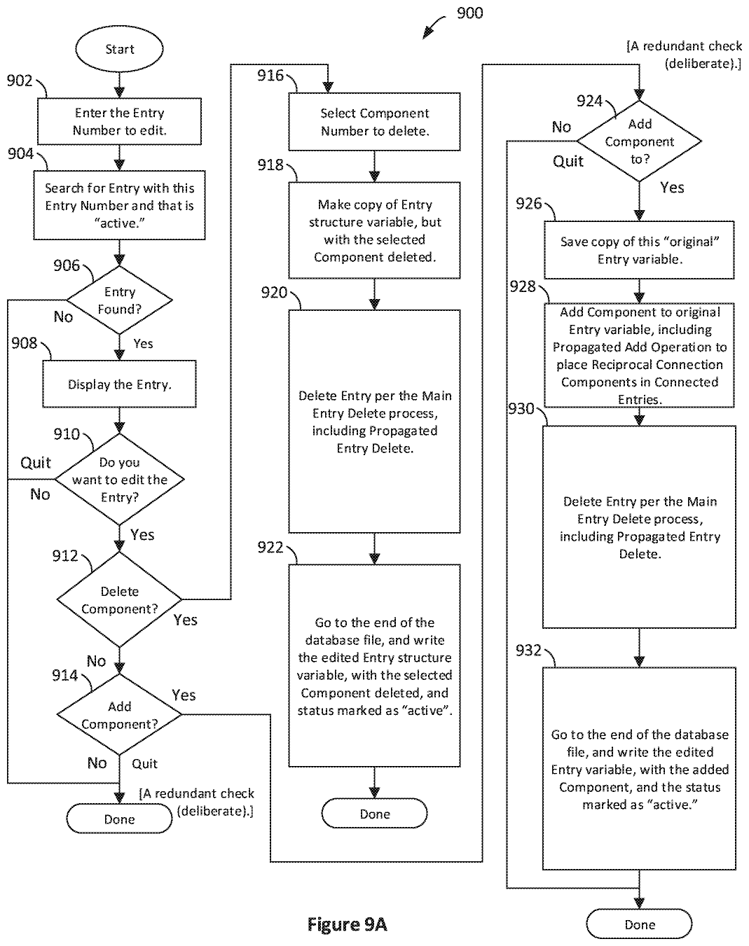

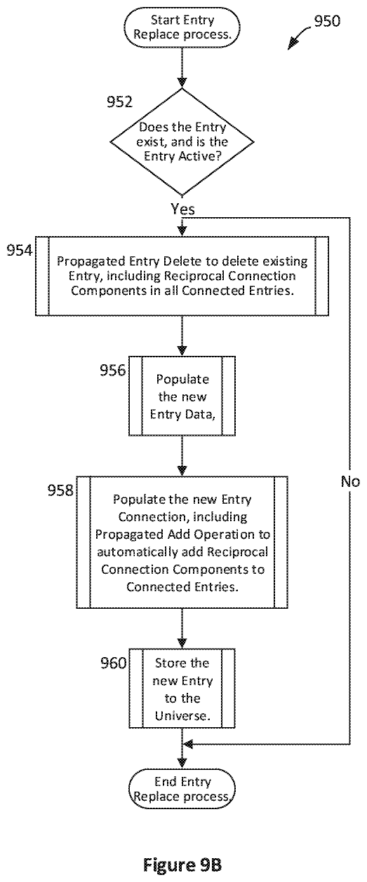

FIG. 9A is a flowchart illustrating an example of a method 900 for editing an entry in a database, according to some embodiments. In some embodiments of the database, an Entry can be edited only by adding a Component or by deleting a Component. This may be done, for example, by the Main Entry Delete process (described elsewhere as method 800), which includes Propagated Entry Delete (described elsewhere), and then writing the edited version of this Entry (Entry number unchanged) to the end of the database file on the drive (either with a Component deleted or a new Component added, depending on what the user selected).

The method 900 starts in at block 902 an Entry number to be edited can be entered and is received by the database engine. At block 904 the method performs a search for the Entry having the Entry number and that is marked as an active Entry. At block 906, if the entry is not found, the search completes (“done”). If the entry is found, at block 908 the entry may be displayed. At block 910, the method can offer the option of whether a user wants to edit the Entry. If not, the search is complete. If it is desired to edit the Entry, the method proceeds to block 912 where it determines if a Component of the Entry should be deleted. If “no” the method proceeds to block 914 where determines if a component should be added, and if not, the method completes. If a component should be added the method proceeds to block 924.

If at block 912 the method receives an indication to delete a component the method proceeds to block 916 where the Component to delete is selected. At block 918 the method makes a copy of the Entry structure that includes the Component but with the selected Component deleted. At block 920, the Entry is deleted per the Main Entry Delete process, which includes Propagated Entry Delete. At block 922, the method goes to the end of the database file and writes the edited Entry structure with the selected Component deleted, and having status marked as “active” then the method completes.

Referring back to block 924 (where a component is to be added to an Entry), the method can check to see if in fact a component should be added and if not, the method completes. This is a deliberately implemented redundant check. If a component is to be added, at block 926 the database engine can save a copy of this original Entry structure. Then at block 928, the method can proceed with the database engine adding the desired Component to the original Entry structure (or variable), including Propagated Add Operation of Reciprocal Connection Components in Connected Entries. The method can then proceed to block 930 where the Entry is deleted per the Main Entry Delete process, which includes Propagated Entry Delete. Then at block 932, the method 900 can go to the end of the database file and write the edited Entry with the added Component having the status marked as “active.” The method 900 then completes.

FIG. 9B shows a simpler alternative to editing an Entry by simply replacing an existing Entry with another Entry with the same Entry Number. Method 950 block 952 checks that the Entry to Replace exists before proceeding. Then Method 950 block 954 performs a Propagated Entry Delete (detailed elsewhere herein) to remove the Entry and its associated Reciprocal Connection Components from the Connected Entries (if any). Next, the data for the new Entry is populated in block 956, which includes populating Entry Number (using the Entry Number of the deleted Entry), Entry Name, and the Numeric, Text, and Date-Time Components. Then, Method 950 block 958 populates the Entry Connections with a Propagated Add Operation (detailed elsewhere herein), which adds the Reciprocal Connection Components to the Connected Entries in addition to adding the Connection Components to this Entry (Origin Entry). Finally, this new Entry is stored at the end of the Universe file (detailed elsewhere herein) per block 960.

FIG. 10 is a flowchart illustrating an example of a method 1000 for the database engine operation to “explode” an entry, that is, query a connection Component of the type explosion, according to some embodiments. This is a capability of the database engine described herein that is unique. At block 1002 of the method 1000 the database engine receives the Entry number of the Entry to explode. At block 1004 the database engine identifies the Entry to be exploded, if it exists. At block 1006 the database engine identifies the explosion data components of this Entry, if any. At block 1008 the database engine provides the Entry corresponding to the entry number of each explosion component in the Entry to be exploded. As a faster alternative, the Explode operation can be implemented by just outputting the Connection Entry Number, Reference Designator (if any), and the name of the Connected (Explode) Entry (if it has a name), since this information is stored locally in the Explode Connection Component, hence not requiring a (potentially time-consuming) seek operation to the Connected Entry (Explode Entry), which would be required to output the Explode Entry. These may be in any manner desired, for example, print it out, provided on a display, provided in another file, or the like.

FIG. 11 is a flowchart illustrating an example of a method 1100 for a database engine operation to “implode” an entry, according to some embodiments. The method 1100 begins and at block 1102 receives an as input an Entry number of the Entry to “implode” at block 1104, the method finds the Entry associated with the Entry number input if it exists. At block 1106 the method determines the implosion components of this Entry, if any exists. Finally, at block 1108 the method can provide as an output (e.g., print, display or communicate) the Entry corresponding to the implosion Entry number in each implosion component (if any) in the Entry to be imploded and the corresponding reference designator (if any exist) and then the method can complete. As a faster alternative, the Implode operation can be implemented by just outputting the Connection Entry Number, Reference Designator (if any), and the name of the Connected (Implode) Entry (if it has a name), since this information is stored locally in the Implode Connection Component, hence not requiring a (potentially time-consuming) seek operation to the Connected Entry (Implode Entry), which would be required to output the Implode Entry.

FIG. 12 is a flowchart illustrating an example of a method 1200 for a flat-connection (“Flat-Track”) query operation, according to some embodiments. The method 1200 begins and at block 1202 the method can receive and enter the Entry number of the Entry in which to perform the flat connection query operation, and then at block 1204, the method can find this entry if it exists. The method 1200 then proceeds to block 1206 where, if this Entry exists, the method finds the flat connection components in this Entry (if any). Then at block 1208, the method 1200 can output the Entry corresponding to the flat connection entry number of each flat component (if any) also, the method can output the corresponding reference designator (if any exists). As a faster alternative, the Flat-Track operation can be implemented by just outputting the Connection Entry Number, Reference Designator (if any), and the name of the Connected (Flat-Track) Entry (if it has a name), since this information is stored locally in the Flat-Track Connection Component, hence not requiring a (potentially time-consuming) seek operation to the Connected Entry (Flat-Track Entry), which would be required to output the Flat-Track Entry.

FIG. 13 is a flowchart illustrating an example of a method 1300 for a custom-connection (Custom-Track) query operation, according to some embodiments. As described herein, some embodiments may not implement a custom connection. Accordingly, some embodiments may not need to implement a Custom-Track query operation. At block 1302 the method receives an entry number of the Entry and the name of the type of Custom-Track Connection component contained in this Entry in which to perform the custom-connection query operation. In some embodiments, the entry number is received via a user input or an API. Also, in some embodiments, it may not be necessary to know the name of the Custom-Track Connection Component; in that case, the database engine will just output all Custom-Track Connections for the Entry. At block 1304, the method 1300 finds the above specified Entry (if it exists) on which to perform the custom connection query. The method 1300 then proceeds to block 1306 where if the Entry exists, the method 1300 finds the custom-connection components of the above-specified custom type, if any, in this Entry. The method 1300 then proceeds to block 1308 where, if the custom connection components exist in the Entry, the method outputs the Entry corresponding to the custom connection entry number in each custom connection component also, the method 1300 can print or otherwise output the corresponding reference designator, if any exist. As a faster alternative, the Custom-Track query operation can be implemented by just outputting the Connection Entry Number, Reference Designator (if any), name of the Custom-Track Connected Entry (if it has a name), the Custom-Track Reciprocal Connection Component Connection Name (which is the Reciprocal Component Name), if this Component exists, and the Reference Designator of the Custom-Track Reciprocal Connection Component, if this Component exists since this information is stored locally in the Custom-Track Connection Component, hence not requiring a (potentially time-consuming) seek operation to the Custom-Track Connected Entry, which would be required to output the Custom-Track Connected Entry.

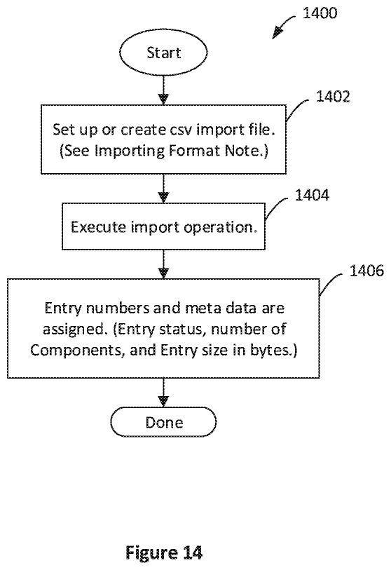

FIG. 14 is a flowchart illustrating an example of a method 1400 for importing information from files (e.g., spreadsheets, database tables, etc.), according to some embodiments. In some embodiments, to facilitate compatibility with other applications, this database engine can import data from spreadsheets or database tables using, for example, a csv file format or another suitable file format. In some embodiments, the database engine is operable to import connection Components. For example, a special character may be included in a data field to indicate a connection exists between that data and other data, the other data also including an associated special character. In some embodiments however, connection Components must be added after the data is entered into the database file by the database engine. Referring to FIG. 14, the method 1400 begins in at block 1402 prepares to import or receive a file, using for example typical file import techniques. At block 1404, the method 1400 executes the import operation to receive the file. Finally, at block 1406, the method 1400 determined and assigns entry numbers in the corresponding metadata to the information received in the file for example, entry status, number of components, and entry size (e.g., in bytes). While importing a file requires certain knowledge of the information to be imported, receiving such information in the file and setting up the corresponding Entry structure by the database engine does not indicate a predetermined schema or table configuration is required. Instead, just as in the examples where a user were to be entering the data, the Entry structures and corresponding Components may be configured as described herein to allow the ingest and storage, in a format where searches and queries can be made, of any type of data. In some examples of import, each import operation uses one csv file. In some embodiments, all the entries are of the same type. For example, the same Components in the same order, one Entry per line, but Components can be blank. To import other types of Entries, the database engine can use other import operations with other csv files. In some embodiments, the first line of a csv ingested represents the Component names, the second line of csv file represents the Component units (which may be optional if there are not Component units). Also, some embodiments can have blank Component units by making this line just n-1 commas, where n is the number of Component units.

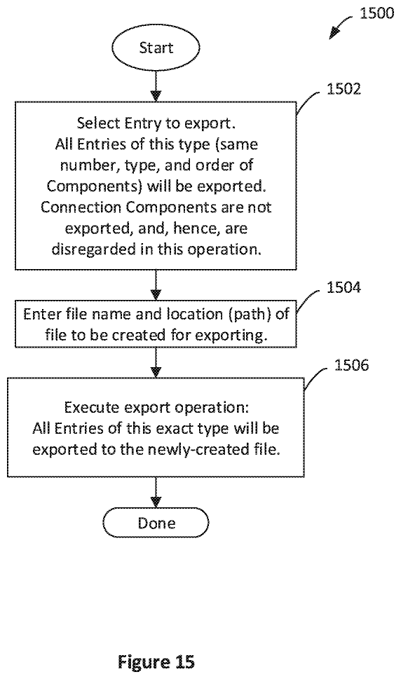

FIG. 15 is a flowchart illustrating an example of a method 1500 for exporting information from a database as described herein to a file (e.g., spreadsheets, database tables, etc.), according to some embodiments. For example, to facilitate compatibility with other applications, the database engine can export data stored in Entry structures including the Component structures to spreadsheets or database tables using csv file format. Referring to FIG. 15, method 1500 proceeds to block 1502 where the database engine can receive an input indicating one or more Entries to export. For example, the database engine may receive a single-entry number of an Entry to export, or the database engine may receive a range of entry numbers to export the respective Entries. At block 1504 the method 1500 receives an input indicating the name of the file to be generated for export, and a path indicating where the file (e.g., a csv file) should be saved to, or provided to. In some embodiments, the exported file is a csv file. In other embodiments, the exported file is of a different format. Then at block 1506, the database engine can execute an export operation where all of the identified Entries of the indicated type will be exported to the newly created file and the file is saved to the location that was indicated by the location input.

In some embodiments, only of the Entries of the same type (same number, type, and order of Components) can be exported in an export operation, and they will be exported to a single csv file, such that Entries with the same number and type of Components, but in different order will not be exported. In some embodiments, the dbe can perform “clean-up” operations to arrange all Entries with the same type and number of Components in the same Component order, hence facilitating export of all Entries with the same number and type of Components, irrespective of order. Some embodiments can use a separate export operation for each type of Entry, and it tells the type of Entry to export by selecting a representative Entry, and exports all Entries with the same number, type, and order of Components to a single export file; however, another embodiment can add a feature in which different types of Entries can be exported in a single export operation such that the dbe will automatically create multiple export files (csv or equivalent), one file for each type of Entry exported.

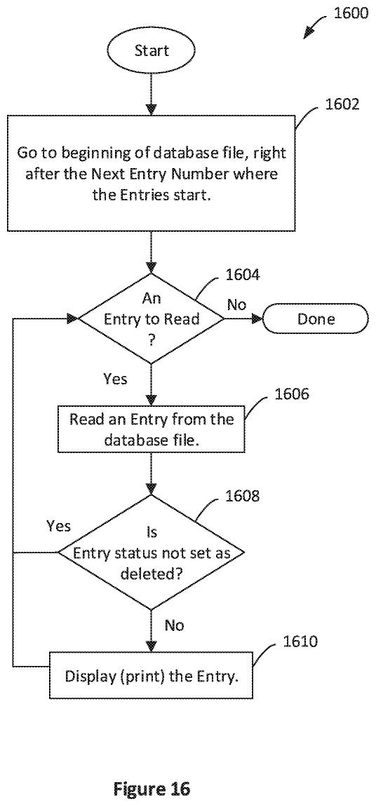

FIG. 16 is a flowchart illustrating an example of a method 1600 for viewing deleted entries, according to some embodiments. This operation can print out all Entries that have been deleted. The dbe searches the status character of every Entry (e.g., “Status” in Box 1, FIG. 2), and for each Entry with the status character set to ‘d’ (for “deleted”), it outputs (prints) the respective Entry. Referring to FIG. 16, at block 1602 the database engine indexes to near the beginning of the database file right after the next entry number with the Entries saved in the database file start right under DVIS. Then at block 1604 the database engine determines if there is an entry to read and if not, the method stops. However, if there is an entry to read the method proceeds to block 1606 with a database engine reads an Entry from the database file. The method then proceeds to block 1608 where determines if the entry status is not set as deleted. If the entry status is not set as deleted (e.g., “yes”) the method 1600 loops back to block 1604, and proceeds determine again if there's an entry to read. If the entry status is set as deleted (e.g., “no” to the determination of whether the entry status is not set as deleted), the method proceeds to block 1610 where it can display or provide the output the deleted Entry (or Entries). Block 1604 then checks if there are more Entries to read; if not, the process (method 1600) ends, and if there are more Entries to read, block 1606 reads another Entry to continue method 1600.

### Defrag Operation

FIG. 17 is a flowchart illustrating an example of a method 1700 for a defragmentation operation, e.g., to purge deleted entries. Since this dbe can work directly on the database file on the drive, and not in memory (RAM), deleted Entries are marked as deleted, but are still in the file. To actually remove deleted Entries from the database file, occasionally run the built-in defragmentation utility to execute a Defrag operation. That is, embodiments of this program may be different from most programs because the database file created by the database engine may not load into and work from memory like Microsoft Excel and most other PC programs. Instead, this database engine may work directly from the drive (disk or SSD) such that the data is stored on the disk or SSD. As such, when Entries are “deleted”, they are marked as “deleted,” but they are still in the database file, using disk space. As more Entries are deleted more disk space is used by deleted Entries. To eliminate these deleted Entries from the file, occasionally run the Defrag utility (selected from the main menu). This removes the deleted Entries from the database file by recopying the database file with the deleted Entries not included in the copy operation. This minimizes disk space used by the database file; hence, defrag should be occasionally performed, especially when a lot of Entries have been deleted.

Referring to FIG. 17, the method 1700 starts and receives an input indicating to perform a defragmentation operation on the structured data (e.g., the database file) at block 1702. The input may be provided via a user interface or by an API. The method 1700 then proceeds to block 1704 where it copies all the contents from the database file except for deleted Entries to a temporary file thus eliminating the deleted Entries. When done the database engine deletes the database file and renames the temporary file with the database file name hence making the temporary file the new database file.

Light-Weight Variations of this Database Engine.

Lighter-weight versions of this database engine can be created to reduce the database engine executable file size, the Universe data file size, or speed execution. For example, a small embedded application may require only a Flat-Track Connection capability; hence, Explode, Implode, and Custom-Track Connection capability can be removed to produce a smaller footprint for the database engine executable. Or, for example, it may be desired to reduce Universe file size, so Connection data (FIG. 2 Box 7) can be minimized to only the Connection Entry Number, thereby eliminating 4 of the 5 Connection Component data items. This would result in longer Connection query times because the database engine would have to seek to each Connected Entry to know its Entry Name (if any) and the Connection Name (Reciprocal Component Name) and Connection Entry Reference Designator (Reciprocal Reference Designator) in the case of Custom-Track Reciprocal Connection Components (if used). But in a small, embedded application, for example, where data storage space is more important than speed, this could be a proper trade-off.

There are countless other ways that this database engine can be scaled back for smaller footprint or lower processor power (mips) applications depending on the specific needs of the application.

### Examples of Selected Technical Parameters

The following are selected technical details for the current version of this database engine. Maximum values given here are not inherent to the database engine data structure, but only to the current version (as of this writing). Also, this may be subject to specific hardware platform limitations.

Maximum number of data Entries: 9 quintillion

Maximum number of Components in a data Entry: 10 million nominal (depending on the details of the Entry contents).

### Possible Modifications, Additions, and Variations

Cloud Version. Although the first version of this database invention runs on a local computer and stores data in a file on the corresponding local drive, this database engine can be adapted to run and store data in the “cloud,” and service multiple users. Furthermore, although the Universe is coincident with a single file and run on a single drive (volume) in the current version, it may be expanded to traverse multiple drives (RAID) or servers (sharding) in a future Cloud version.

Entry Numbering. Entries are numbered as integers in chronological order as they are entered; however, this can be changed to a different numbering or labeling scheme. Chronological integer Entry numbers are not necessary to use the novel features of this database.

Indexing. An indexing function similar to indexing used in conventional (relational) databases may be added to this database engine to reduce query access times.

ACID Transactions. This may have ACID-compliant transactions added as needed.

API. Possible development of an API to allow database engine function access from other programs, the command line, or a GUI.

Database Engine Language. A simple database language may be developed for this database engine invention if desired by some end users. The underlying “virtual mechanism” data structure, with its built-in adjustability and relationship-tracking (connections) will facilitate keeping any language developed for this database engine simple, hence keeping with the “spirit” of this database engine invention (no complicated languages or complex data format documents).

Memory Execution (RAM). A version of this database engine may be developed that runs out of RAM (instead of from the drive), for smaller, speed-intensive applications. Also, most indexing added will probably be RAM-based, except in the largest database implementations.

Expansion of Search Options—Increase Search Query Power

Expand current search capabilities from AND'ing to also include Boolean OR and NOT.

More search options can be added for each data type beyond interval searching such as searching outside of an interval.

A comprehensive search utility can be added to this database based on “regular expressions.” Any desired search over the four Component data types can be implemented as needed for future versions of this database.

A method comprising the export selection process as described in FIG. 15, such that you pick an Entry “like” the Entry that you want to export, and the database engine exports all Entries with the same number, type, and order of Components as the “like” Entry selected. Also, a modification of this such that all Entries with the same number and type of Components irrespective of order will be exported. This may be accomplished in conjunction with “clean-up” functionality as mentioned above.

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure. For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A data storage and retrieval system, comprising:
one or more non-transitory computer storage mediums configured to store processor-executable instructions;
one or more processors coupled to the one or more non-transitory computer storage mediums, wherein the one of more processors are configured to execute the processor-executable instructions to:
configure the one or more non-transitory computer memory components according to a plurality of logical entry structures and component structures as data content is being processed for storage in the entry structures, each entry structure including
(i) an Entry Name, (ii) a Fast Find keyword list, (iii) an entry structure size, (iv) a unique entry structure number, (v) a status of the entry structure, (vi) a total number of component structures in the entry structure, each entry structure having one or more component structures, and (vii) the component structures in the respective entry structure,
each of the component structures in a respective entry structure including (i) a component structure name, (ii) a component structure type, and (iii) component data content, each component structure being contained in only one entry structure, wherein each respective component structure in an entry structure defined as one of a numeric data type, a text data type, a date data type, or a connection data type, and wherein each connection data type component structure including an entry structure number indicating an entry structure having a hierarchical connection to the respective entry structure.

2. The data storage and retrieval system of claim 1, wherein the one or more processors are configured to execute the processor-executable instructions to perform a transaction to change information stored in an entry structure of the plurality of entry structures.

3. The system of claim 1, wherein at least one component of the plurality of entry structures includes a connection data type component structure.

4. The system of claim 2, wherein the connection data type component is an explosion-type connection component structure comprising an entry structure number.

5. The system of claim 4, wherein the explosion-type connection component structure further comprises a reference designator.

6. The system of claim 2, wherein the connection data type component structure is an implosion-type connection component structure comprising an entry structure number.

7. The system of claim 2, wherein the connection data type component is a flat-type connection component structure comprising an entry structure number.

8. The system of claim 1, wherein the connection data type component structure is a custom-type connection component structure comprising a connection entry structure number.

9. The system of claim 1, wherein one or more processors are configured to execute the processor-executable instructions to:
store a first entry structure of the plurality of entry structures, the first entry structure including a first entry number and an explosion-type connection component structure; and
store a second entry structure of the plurality of entry structures, the second entry structure including a second entry structure number and an implosion-type connection component structure, wherein the second entry structure implosion-type connection component includes the first entry structure number indicating the first entry structure has a superordinate hierarchical relationship relative to the second entry structure, and wherein the first entry structure explosion-type connection component structure includes the second entry structure number indicating the second entry structure has a subordinate hierarchical relationship relative to the first entry structure.

10. The system of claim 1, wherein the one of more processors are configured to execute the processor-executable instructions to:
store a first entry structure of the plurality of entries, the first entry structure including a first entry structure number and an implosion-type connection component structure; and
store a second entry of the plurality of entry structures, second entry structure including a second entry structure number and an explosion-type connection component structure, wherein the second entry explosion-type connection component structure includes the first entry structure number indicating the second entry structure has a subordinate hierarchical relationship to the first entry structure, and wherein the first entry structure implosion-type connection component structure includes the second entry structure number indicating the first entry structure has superordinate hierarchical connection to the second entry structure.

11. The system of claim 1, wherein the one of more processors are configured to execute the processor-executable instructions to:
store a first entry structure of the plurality of entries, the first entry structure including a first entry structure number and a flat-type connection component structure; and
store a second entry structure of the plurality of entry structures, second entry structure including a second entry structure number and a flat-type connection component structure, wherein the second entry structure flat-type connection component structure includes the first entry structure number indicating the second entry structure has a flat hierarchical relationship to the first entry structure, and wherein the first entry structure flat-type connection component structure includes the second entry structure number indicating the first entry structure has a flat hierarchical connection to the second entry structure.

12. The system of claim 1, wherein the one of more processors are configured to execute the processor-executable instructions to:
store a first entry structure of the plurality of entry structures, the first entry structure including a first entry structure number and a custom-type connection component structure, wherein the custom-type connection component structure including an entry structure number of a second entry indicating that the first entry structure has a connection to the second entry, the custom-type connection component structure further comprising a reference designator representative of the connection between the first entry structure and the second entry structure.

13. The system of claim 1, wherein the transaction includes populating a first entry structure of the plurality of entry structures, wherein populating the first entry structure includes:
storing the Entry Name,
storing the Fast Find keyword list,
generating and storing an entry structure size of the first entry structure,
generating and storing an entry structure number of the first entry structure,
generating and storing a status of the first entry structure;
determining the number of component structures for the first entry structure and storing the number of component structure in the first entry structure; and
generating and storing data in component structures of the first entry structure.

14. The system of claim 1, wherein the one or more non-transitory computer storage mediums includes at least two non-transitory computer storage mediums, and wherein the at least two non-transitory computer storage mediums include a solid-state drive, wherein the plurality of entry structures are stored on the first memory component structure.

15. The system of claim 12, wherein the at least at least two non-transitory computer storage mediums include one or more solid state memory chips, wherein the processor-executable instructions to operate the database engine are stored on the second memory drive.

16. A method for storing and retrieving data in a computer system having one or more non-transitory memory components storing processor-executable instructions and one or more computer processors to execute the processor-executable instructions to perform the method, the method comprising:
configuring the one or more computer memory components according to a plurality of logical entry structures, each entry structure including
(i) an Entry Name, (ii) a Fast Find keyword list, (iii) an entry structure size, (iv) a unique entry structure number, (v) a status of the entry structure, (vi) a total number of component structures in the entry structure, each entry structure having one or more component structures, and (vii) the component structures in the respective entry structure,
each of the component structures in a respective entry structure including (i) a component structure name, (ii) a component structure type, and (iii) component data content, each component structure being contained in only one entry structure, wherein each respective component structure in an entry structure defined as one of a numeric data type, a text data type, a date data type, or a connection data type, and wherein each connection data type component structure including an entry structure number indicating an entry structure having a hierarchical connection to the respective entry structure.

17. The method of claim 16, wherein the method further comprises performing a transaction to change information stored in an entry structure of the plurality of entry structures.

18. A method for storing and retrieving data in a computer system having one or more non-transitory memory components storing processor-executable instructions and one or more computer processors to execute the processor-executable instructions to perform the method, the method comprising:
configuring the one or more computer memory components according to a plurality of logical entry structures, each entry structure including a unique entry structure number, and the component structures in the respective entry structure, each of the component structures in a respective entry structure including (i) a component structure name, (ii) a component structure type, and (iii) component data content, each component structure being contained in only one entry structure, wherein each respective component structure in an entry structure is one of a numeric data type, a text data type, a date data type, or a connection data type, and wherein each connection data type component structure includes an entry structure number indicating an entry structure having a hierarchical connection to the respective entry structure; and
populating the plurality of entry structures with data content, where the component structure type is generated based on the data content as the data content is processed to populate the plurality of entry structures.

19. The method of claim 18, wherein the method further comprises adding a first connection data type component structure to an existing first entry structure, the first connection data type component structure including the entry number corresponding to the entry number of an existing entry structure.

20. The method of claim 18, wherein the method further comprises adding a new entry structure, the new entry structure including a first connection data type component structure having an entry number corresponding to an existing entry structure.
